(19) United States
(12) Patent Application Publication
(10) Pub. No.: US 2019/0150622 A1
(43) Pub. Date: May 23, 2019

(54) ARMRESTS INCLUDING ONE OR MORE LAMINATES AND METHODS AND KITS FOR MAKING THE SAME

(71) Applicant: SABIC Global Technologies B.V., Bergen op Zoom (NL)

(72) Inventors: Somasekhar Bobba, Bangalore (IN); Rahul Sagare, Houston, TX (US); Raj Kumar, Bangalore (IN); Ashwin Kumar, Bangalore (IN); Kylie Speirs, Houston, TX (US); Peter Zuber, Houston, TX (US); Matthew Buratto, Houston, TX (US); Ranvir Soni, Houston, TX (US); Roy Watson, Houston, TX (US); Andy May, Houston, TX (US)

(21) Appl. No.: 16/091,375

(22) PCT Filed: Apr. 4, 2017
(86) PCT No.: PCT/IB2017/051928

§ 371 Date: Oct. 4, 2018

Related U.S. Application Data
(60) Provisional application No. 62/318,140, filed on Apr. 4, 2016.

(51) Int. Cl. A47C 7/54; B29C 45/14; B32B 27/08; B32B 27/28

(52) U.S. Cl. CPC A47C 7/543; B29C 45/14631; B64D 11/0644; B32B 27/281; B32B 27/08

(57) ABSTRACT

This disclosure includes armrests having one or more laminates and methods and kits for making the same. Some armrests include an elongated beam extending between a first end and a second end, the elongated beam having one or more laminates configured to be disposed along the elongated beam, each including a plurality of fibers dispersed within a matrix material, and a reinforcing structure having a plurality of ribs, the reinforcing structure configured to be coupled to the one or more laminates, where the first end of the elongated beam is configured to be pivotally coupled to a mount. In some armrests, the one or more laminates are configured to be disposed along the elongated beam such that the one or more laminates define a channel and/or an arch extending between the first and second ends.

### CROSS-REFERENCE TO RELATED APPLICATIONS

This application claims the benefit of priority of U.S. Provisional Patent Application No. 62/318,140 filed Apr. 4, 2016, which is hereby incorporated by reference in its entirety.

### BACKGROUND

### 1. Field of Invention

The present invention relates generally to composite structures, and more specifically, but not by way of limitation, to armrests including one or more laminates and methods and kits for making the same.

### 2. Description of Related Art

Reducing the weight of vehicle components, such as, for example, interior components, exterior components, engine components, and/or the like, can be beneficial. For example, lighter components can provide for increased fuel economy and decreased emissions. However, when designing a lighter component, attention must be paid to ensure that the component satisfies design loadings and cost constraints.

### SUMMARY

Some embodiments of the present armrests are configured to have a reduced weight and meet design loadings by including an elongated beam extending between a first end and a second end and one or more laminates disposed along the beam (e.g., which, in some embodiments, can define an arch and/or channel extending between the first and second ends).

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

As used in this disclosure, a “lamina” is a layer of material that is formed by introducing a matrix material into an arrangement of fibers, and “laminae” is the plural form of lamina. A “laminate” is a layer of material including one or more laminae, whether or not consolidated.

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1A is a perspective view of a first embodiment of the present armrests, including one or more laminates, a reinforcing structure, and a cover.

FIGS. 1B-1F are side, top, bottom, front, and back views, respectively, of the armrest of FIG. 1A.

FIG. 1G is a cross-sectional side view of the armrest of FIG. 1A, taken along line 1G-1G of FIG. 1C.

FIGS. 1H and 1I are cross-sectional end views of the armrest of FIG. 1A, taken along lines 1H-1H and 1I-1I, respectively, of FIG. 1B.

FIG. 1J is an exploded perspective view of the armrest of FIG. 1A.

FIGS. 2A and 2B are perspective views of the one or more laminates of the armrest of FIG. 1A.

FIG. 3A is a schematic exploded view of a laminate, which may be suitable for use in some embodiments of the present armrests.

FIG. 3B is a schematic exploded view of a laminate, which may be suitable for use in some embodiments of the present armrests.

FIGS. 4A and 4B are perspective views of at least a portion of the reinforcing structure of the armrest of FIG. 1A.

FIGS. 5A and 5B are perspective views of the cover of the armrest of FIG. 1A.

FIG. 6A is a perspective view of a second embodiment of the present armrests, including one or more laminates, a reinforcing structure, and a cover.

FIGS. 6B-6F are side, top, bottom, front, and back views, respectively, of the armrest of FIG. 6A.

FIG. 6G is an exploded perspective view of the armrest of FIG. 6A.

FIG. 7A is a perspective view of a third embodiment of the present armrests, including one or more laminates, a reinforcing structure, and a cover.

FIGS. 7B-7F are side, top, bottom, front, and back views, respectively, of the armrest of FIG. 7A.

FIG. 7G is a cross-sectional side view of the armrest of FIG. 7A, taken along line 7G-7G of FIG. 7C.

FIG. 7H is a cross-sectional end view of the armrest of FIG. 7A, taken alone line 7H-7H of FIG. 7B.

FIG. 7I is an exploded perspective view of the armrest of FIG. 7A.

FIGS. 8A and 8B are perspective views of the one or more laminates of the armrest of FIG. 7A.

FIGS. 9A and 9B are perspective views of at least a portion of the reinforcing structure of the armrest of FIG. 7A.

FIGS. 10A-10C are perspective, top, and bottom views, respectively, of the cover of the armrest of FIG. 7A.

FIG. 11A is a perspective view of a fourth embodiment of the present armrests, including one or more laminates, a reinforcing structure, and a cover.

FIG. 11B is a schematic cross-sectional end view of the armrest of FIG. 11A and is not drawn to scale.

FIG. 12A is a perspective view of a fifth embodiment of the present armrests.

FIGS. 12B and 12C are cross-sectional end views of the armrest of FIG. 12A, taken along lines 12B-12B and 12C-12C, respectively, of FIG. 12A.

FIG. 12D is a cross-sectional side view of the armrest of FIG. 12A, taken along line 12D-12D of FIG. 12A.

FIGS. 13A and 13B are schematic views of a support element, which may be suitable for use in some embodiments of the present armrests.

FIGS. 14-16 are schematic views of elbow rests and privacy dividers, which may be suitable for use in some embodiments of the present armrests.

FIG. 17 illustrates one or more steps of an injection molding process, which may be suitable for use in some embodiments of the present methods.

FIG. 18 depicts a design loading for the armrest of FIG. 1A.

FIGS. 19A-19E depict stress within the armrest of FIG. 1A when subjected to the design loading of FIG. 18.

FIG. 20 depicts a design loading for the armrest of FIG. 1A.

FIGS. 21A-21E depict stress within the armrest of FIG. 1A when subjected to the design loading of FIG. 20.

FIG. 22 depicts a test fixture used to structurally test embodiments of the present armrests.

FIG. 23 is a graph showing applied force at failure for embodiments of the present armrests.

FIG. 24 is a graph showing predicted and actual applied force vs. displacement curves for an embodiment of the present armrests.

FIGS. 25A and 25B depict predicted and actual locations of failure, respectively, for an embodiment of the present armrests.

FIGS. 26-29 depict design volumes that are usable with topology optimization software to identify suitable configurations for reinforcing structures of armrests.

FIGS. 30A and 30B depict topology optimization solutions that may be indicative of suitable configurations for reinforcing structures of armrests.

### DETAILED DESCRIPTION

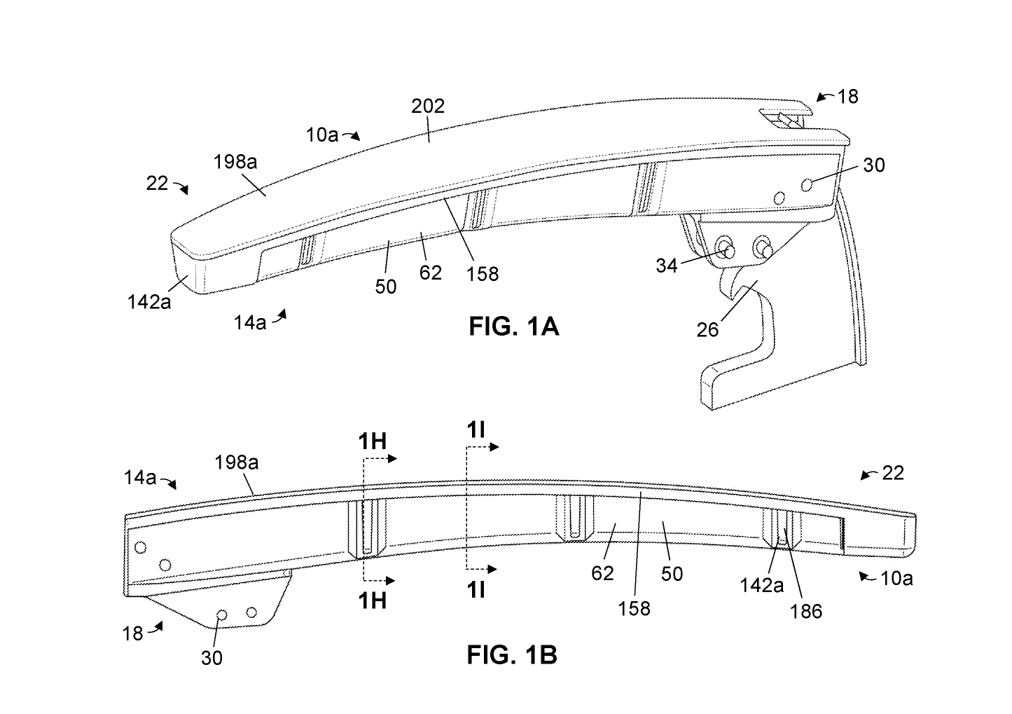

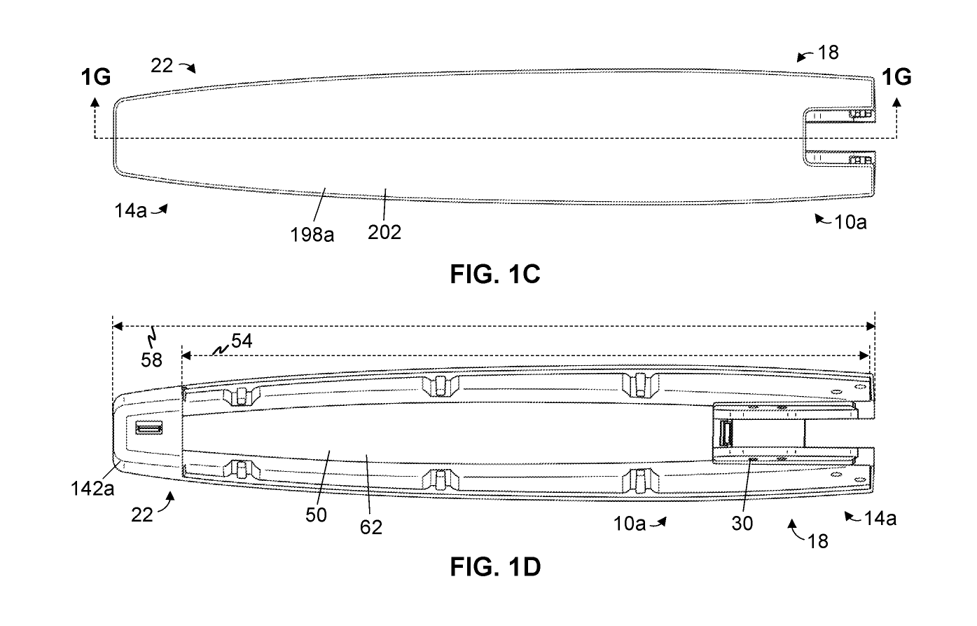

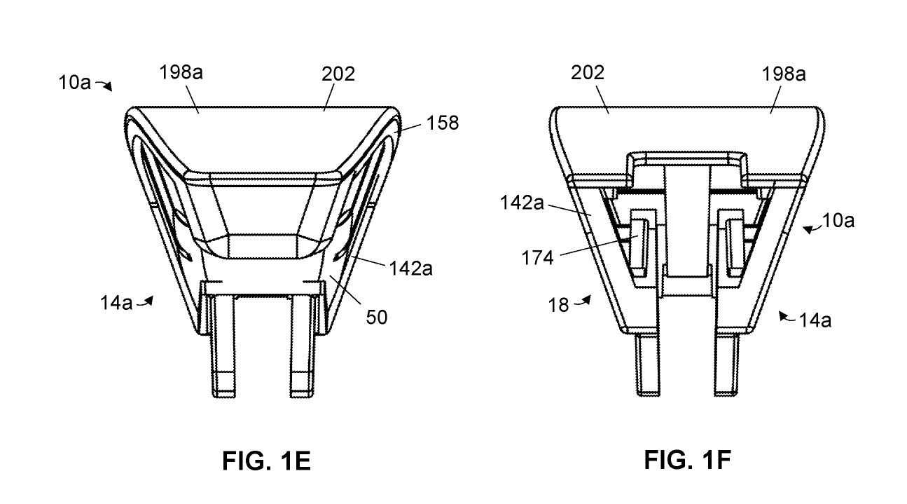

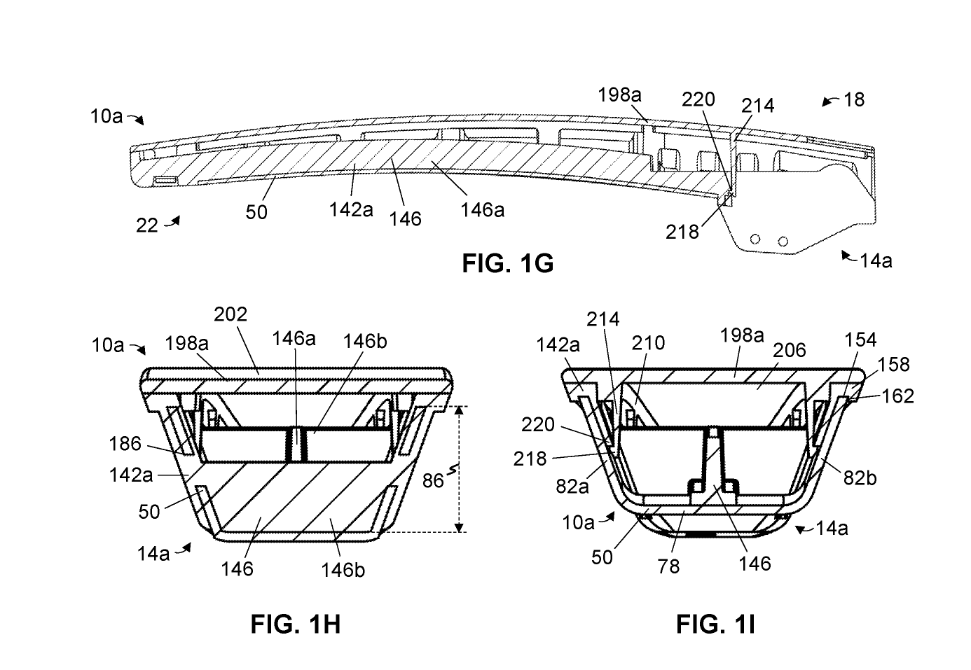

Referring to FIGS. 1A-1J, shown is a first embodiment 10a of the present armrests. Armrest 10a includes an elongated beam 14a extending between a first end 18 and a second end 22. Beam 14a can be coupled to and supported by a mount (e.g., 26). As shown, such coupling can be at first end 18, with second end 22 being free (e.g., beam 14a, when coupled to a mount 26, can be characterized as a cantilever beam). For example, first end 18 of beam 14a can define one or more openings or slots 30 configured (e.g., sized and located) to receive one or more fasteners 34 (e.g., pin(s), rivet(s), bolt(s), screw(s), and/or the like) such that the one or more fasteners can be disposed into or through the beam and, for at least one of the fastener(s), into or through a mount (e.g., 26), to couple the beam to the mount (FIG. 1A). One or more fasteners 34 can be coupled to beam 14a and/or a mount (e.g., 26) via one or more bearings or bushings 38, to, for example, mitigate stress concentrations in the beam and/or the mount, facilitate pivoting of the beam relative to the mount (described in more detail below), and/or the like. In other embodiments, coupling of a beam (e.g., 14a) to a mount (e.g., 26) can be accomplished in any suitable fashion, such as, for example, via interlocking features of the beam and the mount, integral formation of at least a portion of the beam and at least a portion of the mount, or the like. A mount (e.g., 26) can comprise any suitable mount, including an existing mount on a vehicle (e.g., an airplane, train, bus, truck, car, or the like), such that, for example, an armrest of the present disclosure (e.g., 10a, 10b, 10c, 10d, 10e, and/or the like) can be installed in place of an existing armrest.

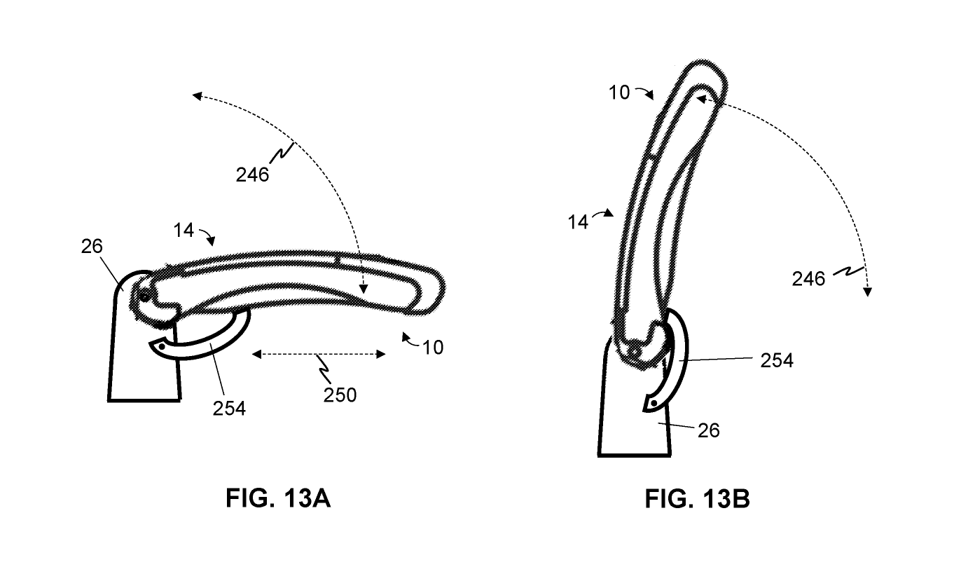

Beam 14a can be configured to be pivotally coupled to a mount (e.g., 26). For example, when beam 14a is coupled to a mount (e.g., 26) via one or more fasteners 34, the beam can be rotated relative to at least one of the fastener(s) and/or the fastener can be rotated relative to the mount, facilitated by one or more bearings or bushings 38, if present, to pivot the beam relative to the mount. Beam 14a can be pivoted relative to a mount (e.g., 26) between a stowed position and a deployed position in which the beam extends further from the mount in a horizontal direction than when the beam is in the stowed position (e.g., FIG. 13B depicts an illustrative stowed position and FIG. 13A depicts an illustrative deployed position). Armrest 10a can be configured such that, when beam 14a is coupled to a mount (e.g., 26), a range of movement of the beam relative to the mount is limited. For example, at least one of one or more fasteners 34 can be coupled to beam 14a such that the fastener contacts a mount (e.g., 26) when the beam is in the deployed position to physically restrict movement of the beam beyond the deployed position and/or at least one of the fastener(s) can be coupled to the beam such that the fastener contacts the mount when the beam is in the stowed position to physically restrict movement of the beam beyond the stowed position.

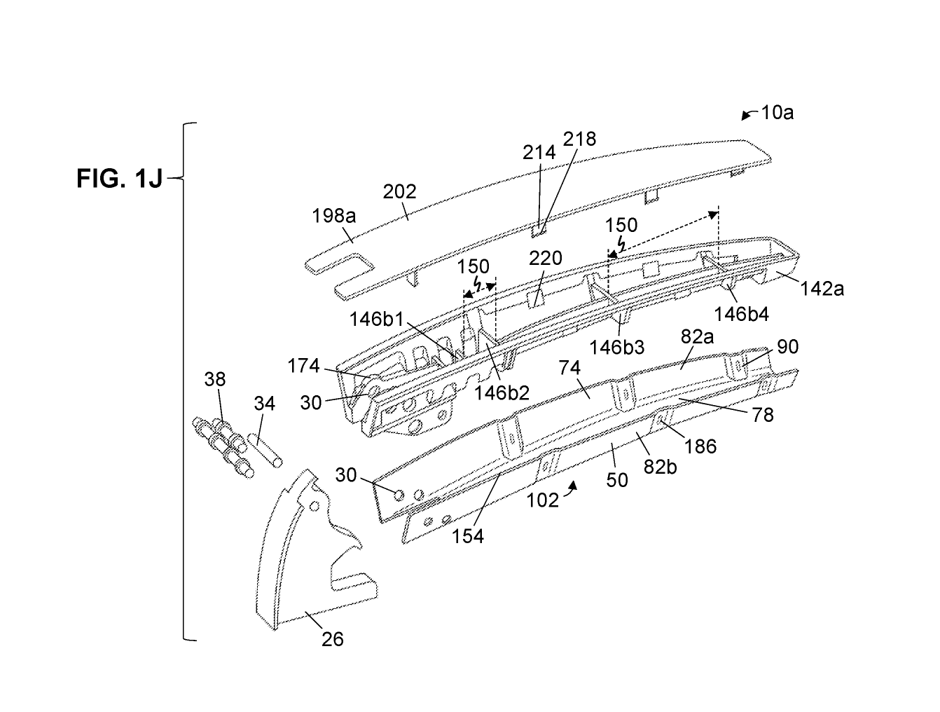

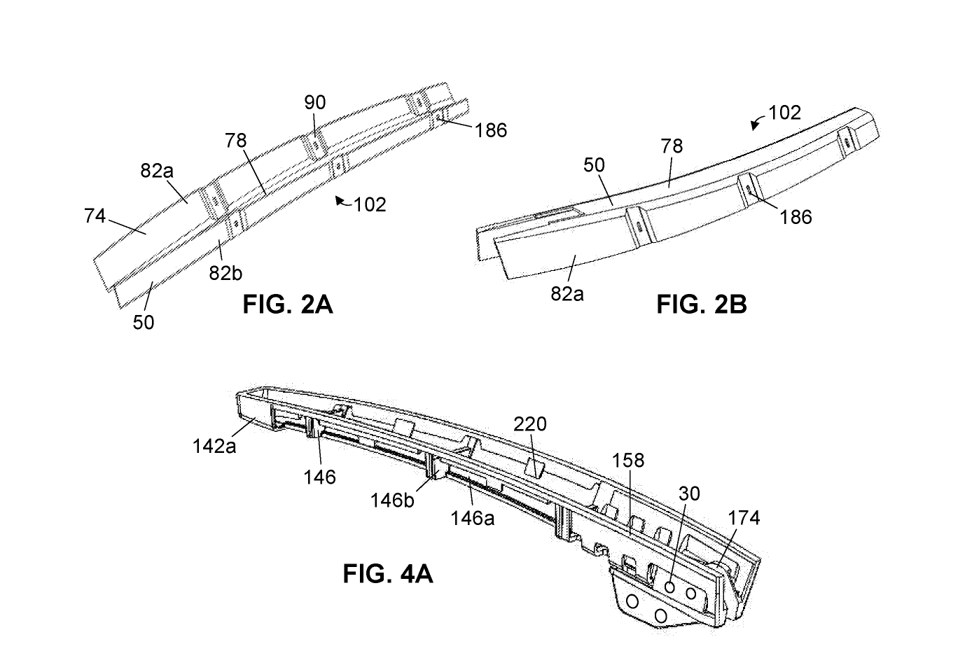

Referring additionally to FIGS. 2A and 2B, beam 14a includes one or more laminates 50 (e.g., one laminate 50, in the depicted embodiment) disposed along the beam. One or more laminates (e.g., 50), as a total set, can include any suitable number of laminate(s) (e.g., 1, 2, 3, 4, 5, 6, 7, 8, 9, 10, or more laminates), and, as used in the following sections, “one or more laminates” and “one or more laminates 50” may refer to any number of the total set (e.g., an individual one of, two or more of, three or more of, or each of the total set). One or more laminates 50 span a distance 54, measured along a length 58 of beam 14a, that is a majority of the length of the beam (e.g., 55, 60, 65, 70, 75, 80, 85, 90, 95, or 100 percent of the length of the beam) (FIG. 1D). In at least this way, one or more laminates 50 can function as a primary support (e.g., a “backbone”) of beam 14a. One or more laminates 50 can define at least a portion of an outermost surface 62 of beam 14a. Thus, one or more laminates 50 can, with minimal to no finishing, provide for an aesthetically pleasing appearance of at least a portion of outermost surface 62 beam 14a, thereby minimizing or eliminating the need for painting, coating, plating, or otherwise covering the at least a portion of the outermost surface (e.g., reducing manufacturing cost and weight).

One or more laminates 50 can be disposed along beam 14a at locations where increased strength and/or stiffness of the beam may be particularly advantageous. For example, one or more laminates 50 can be disposed closer to first end 18 than to second end 22 (e.g., the second end may not include the one or more laminates), thus providing increased strength and/or stiffness to beam 14a where forces and moments carried by the beam may be the largest. For further example, one or more laminates 50 can be disposed such that one or more openings or slots 30 extend through the one or more laminates, thereby increasing a strength of beam 14a at the mounting location of the beam to a mount (e.g., 26).

One or more laminates 50 can be disposed along beam 14a such that the one or more laminates define a channel 74 extending between, but not necessarily to each of, first end 18 and second end 22. For example, one or more laminates 50 can define a cross-section, taken perpendicularly to length 58, that is U- or V-shaped. For further example, one or more laminates 50 can include a bottom portion 78 and opposing side portions, 82a and 82b, that each extend away from, but are not necessarily in direct contact with, the bottom portion. Bottom portion 78 and side portions 82a and/or 82b can include same and/or distinct ones of one or more laminates 50. A depth 86 of channel 74 can decrease from first end 18 to second end 22, such that, for example, a bending stiffness of one or more laminates 50 increases from the second end to the first end (FIG. 1H). One or more laminates 50 can define one or more ridges 90 extending into and/or away from channel 74, which can increase a stiffness of the one or more laminates. An interior of channel 74 (e.g., between side portions 82a and 82b) can provide space for reinforcing structure 142a, cover 198a, one or more elbow rests 262, divider 292, electronics, other components, and/or the like (described in more detail below).

One or more laminates 50 can be disposed along beam 14a such that the one more laminates define an arch 102 extending between, but not necessarily to each of, first end 18 and second end 22. Arch 102 can facilitate one or more laminates 50 in resisting torsion, carrying loads in a direction that is aligned with fibers of the one or more laminates (depending on the lay-up of the one or more laminates, described in more detail below), and following a comfortable, curved shape of beam 14a. At least by including one or more laminates (e.g., 50) that define a channel (e.g., 74) and/or an arch (e.g., 102), the present armrests (e.g., 10a, 10b, 10c, 10d, 10e, and/or the like) can be capable of meeting design loadings, while having a relatively low weight.

One or more laminates (e.g., 50) of the present armrests (e.g., 10a, 10b, 10c, 10d, 10e, and/or the like) can each include any suitable number of laminae (e.g., 1, 2, 3, 4, 5, 6, 7, 8, 9, 10, or more laminae), each having fibers (e.g., 106) dispersed within a matrix material (e.g., 110). A matrix material (e.g., 110) of a lamina can include any suitable matrix material, such as, for example, a thermoplastic material, such as polyethyleneimine, polyetherimide, or a derivative thereof, polyethylene terephthalate, a polycarbonate, polybutylene terephthalate, poly(1,4-cyclohexylidene cyclohexane-1,4-dicarboxylate), glycol-modified polycyclohexyl terephthalate, poly(phenylene oxide), polypropylene, polyethylene, polyvinyl chloride, polystyrene, polymethyl methacrylate, a thermoplastic elastomer, a terephthalic acid elastomer, poly(cyclohexanedimethylene terephthalate), polyethylene naphthalate, polyamide, polysulfone sulfonate, polyether ether ketone, polyether ketone ketone, acrylonitrile butyldiene styrene, polyphenylene sulfide, a co-polymer thereof, or a blend thereof, or a thermoset material, such as an unsaturated polyester resin, a polyurethane, bakelite, duroplast, urea-formaldehyde, diallyl-phthalate, an epoxy resin, an epoxy vinylester, a polyimide, a cyanate ester of polycyanurate, dicyclopentadiene, a benzoxazine, a co-polymer thereof, or a blend thereof.

Fibers (e.g., 106) of a lamina can include any suitable fibers, such as, for example, carbon fibers, glass fibers, basalt fibers, aramid fibers, polyethylene fibers, polyester fibers, polyamide fibers, steel fibers, textile fibers, or a combination thereof. Fibers (e.g., 106) of a lamina can be continuous and/or discontinuous. Fibers (e.g., 106) of a lamina can include yarns, which, in turn, can include braided and/or commingled strands, and such a yarn can include strands of a first material (e.g., a polymeric material) and strands of a second material (e.g., a non-polymeric material) that is different than the first material. Fibers (e.g., 106) of a lamina can be oriented relative to one another within the lamina in any suitable fashion, including, for example, such that the fibers are substantially aligned with and/or angularly disposed relative to one another, such that substantially all of the fibers are substantially parallel to one another (e.g., as in a lamina formed from a unidirectional fiber tape), such that the fibers define a woven structure (e.g., as in a lamina having a plane, twill, satin, basket, leno, mock leno, or the like weave, whether two- or three-dimensional), and/or the like.

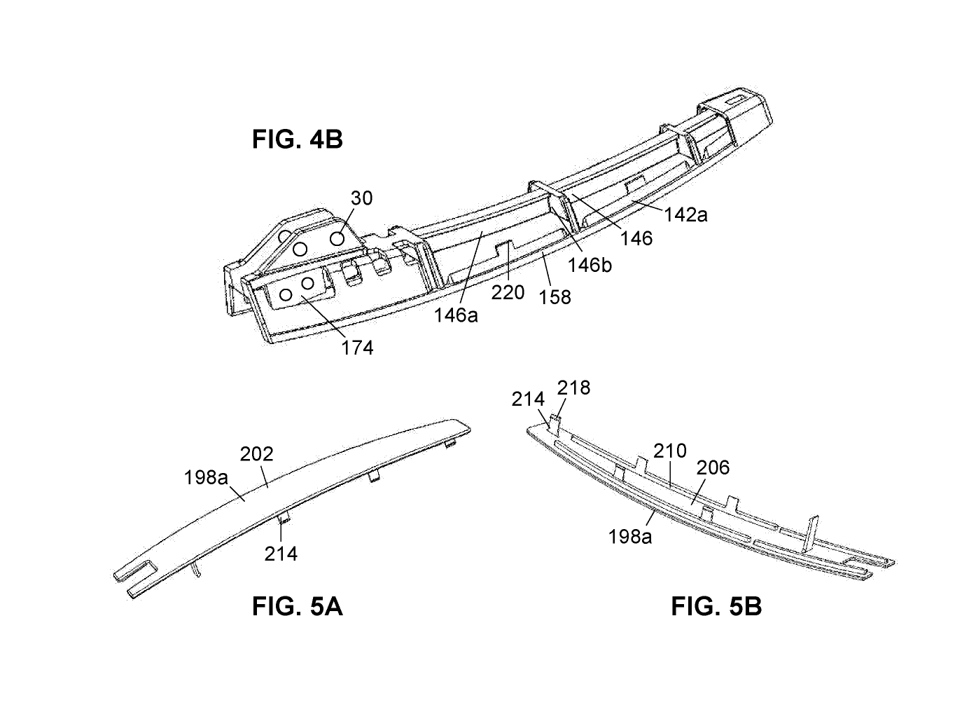

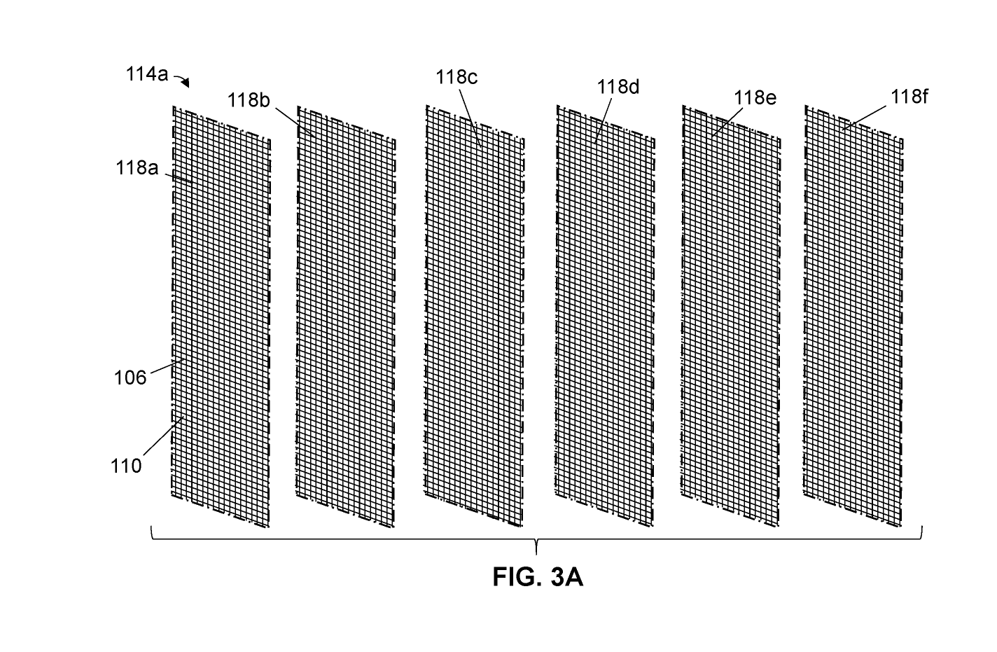

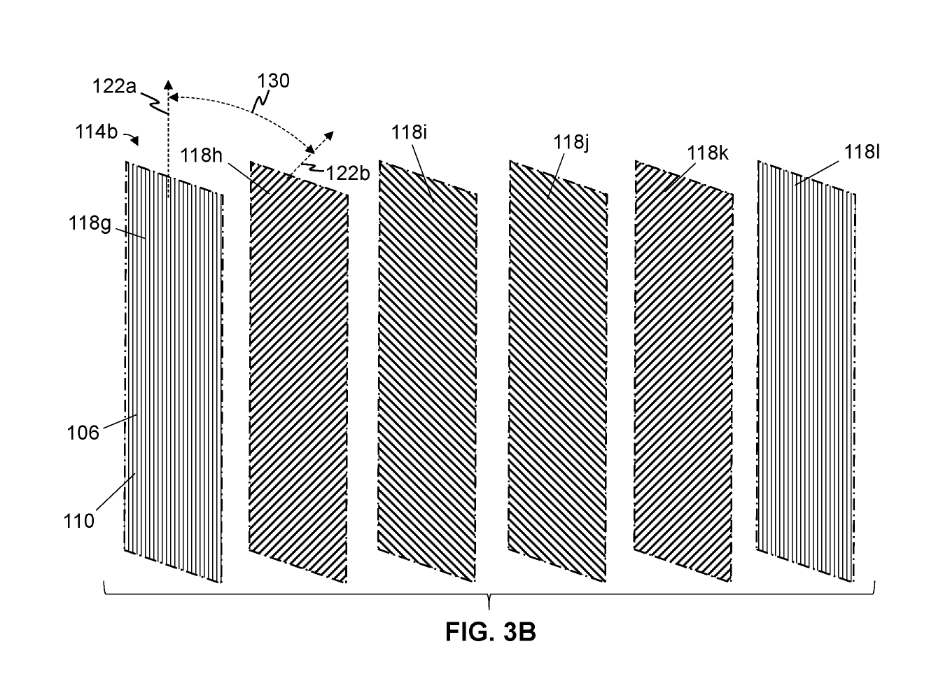

For example, FIG. 3A depicts a schematic exploded view of a laminate 114a, which may be suitable for use in some of the present armrests (e.g., 10a, 10b, 10c, 10d, 10e, and/or the like). Laminate 114a can include a lamina 118a having fibers 106 that define a woven structure. For example, lamina 118a can include a first set of fibers 106 that are substantially aligned with one another and a second set of fibers 106 that are substantially aligned with one another, where the second set of fibers is woven with and angularly disposed relative to the first set of fibers. More particularly, lamina 118a of laminate 114a can be a 0/90 lamina, such that, for example, the first set of fibers is substantially aligned with a long dimension of the lamina, the laminate, and/or a beam (e.g., 14a) along which the laminate is disposed (e.g., the first set of fibers can be characterized as warp fibers), and the second set of fibers is angularly disposed relative to the first set of fibers at an angle of approximately 90 degrees (e.g., the second set of fibers can be characterized as weft fibers). As shown, laminate 114a includes six (6) laminae, 118a-118f, each of which can be a 0/90 lamina; however, other laminates can include 0/90, +30/−60, −30/+60, +45/−45, and/or the like woven lamina(e), and such lamina(e) can be stacked in an symmetric or asymmetric configuration.

For further example, FIG. 3B depicts a schematic exploded view of a laminate 114b, which may be suitable for use in some of the present armrests (e.g., 10a, 10b, 10c, 10d, 10e, and/or the like). Laminate 114b can include a lamina 118g in which substantially all of fibers 106 are substantially parallel to one another (e.g., the lamina can be formed from a unidirectional fiber tape). Fibers 106 of lamina 118g can be aligned in a first direction 122a, and laminate 114b can include a lamina 118h having fibers 106 aligned in a second direction 122b that is angularly disposed relative to the first direction. For example, a smallest angle 130 between first direction 122a and second direction 122b can be from 20 to 70 degrees, 30 to 60 degrees, 40 to 50 degrees, or any angle therebetween. As shown, laminate 114b can include six (6) laminae, 118g-118l, each having fibers that are angularly disposed at approximately 0, 45, −45, −45, 45, and 0 degrees, respectively, relative to a long dimension of the lamina, the laminate, and/or a beam (e.g., 14a) along which the laminate is disposed. While laminae 118g-118l of lamina 114b are stacked in a symmetric configuration, other laminates can include lamina(e) stacked in an asymmetric configuration. Of course, a laminate (e.g., 50, 114a, 114b, and/or the like) can include lamina(e) (e.g., any one or more of laminae 118a-118l), each having fibers that are angularly disposed at any suitable angle relative to a long dimension of the lamina, the laminate, and/or a beam (e.g., 14a) along which the laminate is disposed, such as, for example, at an angle of approximately −85, −80, −75, −70, −65, −60, −55, −50, −45, −40, −35, −30, −25, −20, −15, −10, −5, 0, 5, 10, 15, 20, 25, 30, 35, 40, 45, 50, 55, 60, 65, 70, 75, 80, 85, or 90 degrees. One or more laminates (e.g., 50, 114a, 114b, and/or the like) of the present armrests (e.g., 10a, 10b, 10c, 10d, 10e, and/or the like) can have any suitable thickness, such as, for example, a thickness of 2, 3, 4, 5, 6, or more millimeters (mm).

Provided solely by way of example, in armrest 10a, one or more laminates 50 can include a laminate having ten (10) lamina. Each of the ten lamina can be a woven 0/90 lamina having carbon fibers dispersed within a polyetherimide matrix material. A thickness of each of the ten lamina can be from approximately 0.2 mm to approximately 0.4 mm.

Referring additionally to FIGS. 4A and 4B, beam 14a can include a reinforcing structure 142a that extends between, but not necessarily to each of, first end 18 and second end 22. In some embodiments, a reinforcing structure (e.g., 142a, 142b, 142c, 142d, 142e, and/or the like) may be characterized as and/or can include an elongated body, an arm, a beam, a member, and/or the like. In some embodiments, a reinforcing structure (e.g., 142a, 142b, 142c, 142d, 142e, and/or the like) may be formed from one, two, three, or more distinct parts. Reinforcing structure 142a can be coupled to one or more laminates 50 such that the reinforcing structure facilitates transfer of loads into and/or from the one or more laminates and encourages even distribution of loads across the one or more laminates. For example, reinforcing structure 142a can include a plurality of ribs 146 that extend from one or more laminates 50. In beams (e.g., 14a) having one or more laminates (e.g., 50) that define a channel (e.g., 74), ribs (e.g., 146) of a reinforcing structure (e.g., 142a) can extend into and/or across the channel. Ribs 146 can include one or more longitudinal ribs 146a that extend in a direction that is substantially parallel to length 58 of beam 14a. If reinforcing structure 142a is injected molded, during injection molding, portion(s) of the mold that form one or more longitudinal ribs 146a can function as channel(s) through which injection molding material can flow to other portions of the mold, encouraging structural uniformity throughout the molded reinforcement structure. Ribs 146 can include two or more transverse ribs 146b that extend in a direction that is substantially perpendicular to length 58 of beam 14a. In beam 14a, a distance 150 between longitudinally consecutive ones of transverse ribs 146b can increase from first end 18 to second end 22. For example, a distance 150 between transverse ribs 146b1 and 146b2, which are disposed nearer to first end 18 than to second end 22, can be smaller than a distance 150 between transverse ribs 146b3 and 146b4, which are disposed nearer to the second end than to the first end (FIG. 1J). Configuration (e.g., placement, dimensions, and/or the like) of ribs (e.g., 146) of a reinforcing structure (e.g., 142a) can be optimized using computer-based structural analysis tools. In at least this way, a bending stiffness of beam 14a may increase from second end 22 to first end 18, where forces and moments carried by the beam may be the largest.

For further example, reinforcing structure 142a can abut and/or overlie a majority of, up to including all of, an outside edge 154 of one or more laminates 50, which, in addition to reinforcing the one or more laminates, can protect the one or more laminates from damage (e.g., fraying, delamination, chipping, and/or the like), restrict human contact with at least a portion of the outside edge, which may be sharp, and/or the like. For example, reinforcing structure 142a can include a lip 158 extending outwardly from the reinforcing structure such that, when one or more laminates 50 are coupled to the reinforcing structure, the lip abuts at least a majority of an outside edge 154 of the one or more laminates. Lip 158 can define a recess 162 configured (e.g., sized) to receive outside edge 154 of one or more laminates 50 such that the lip overlies the outside edge.

One or more openings or slots 30 of beam 14a can be defined into and/or through reinforcing structure 142a. For example, reinforcing structure 142a can include a mount portion 174 into and/or through which one or more openings or slots 30 are defined, a thickness of which can be larger than a thickness of adjacent portions of the reinforcing structure. In these ways and others, reinforcing structure 142a may increase a strength of beam 14a at the mounting location of the beam to a mount (e.g., 26).

Reinforcing structure 142a can be overmolded onto one or more laminates 50. For example, one or more laminates 50, one or more laminae of the one or more laminates, and/or one or more arrangements of fibers can be placed into a mold, and a polymeric material can be injected into the mold to overmold the reinforcing structure onto the one or more laminates, the one or more laminae, and/or the one or more arrangements of fibers (e.g., in some instances, forming one or more laminates by joining the one or more laminae with the polymeric material, dispersing the one or more arrangements of fibers into the polymeric material, and/or the like). One or more laminates 50 can define one or more openings or slots 186, and reinforcing structure 142a can be overmolded onto the one or more laminates such that the reinforcing structure is disposed into and/or through the one or more openings or slots, thereby providing for a stronger connection between the one or more laminates and the reinforcing structure. In other embodiments, one or more laminates (e.g., 50) can be coupled to a reinforcing structure (e.g., 142a) in any suitable fashion, such as, for example, via one or more fasteners (e.g., pin(s), rivet(s), bolt(s), screw(s), and/or the like), adhesive, interlocking features of the one or more laminates and the reinforcing structure, and/or the like.

Suitable polymeric materials for a reinforcing structure (e.g., 142a) can include any thermoplastic material described above, any thermoset material described above, and/or the like. In some embodiments (e.g., 10a), a polymeric material of a reinforcing structure (e.g., 142a) can be the same as a matrix material (e.g., 110) of one or more laminates (e.g., 50), which can facilitate overmolding of the reinforcing structure onto the one or more laminates. Though not required in all embodiments, a polymeric material of a reinforcing structure (e.g., 142a) can be fiber-filled, for example, with short and/or long fibers of any fiber-type described above. In other embodiments, a reinforcing structure (e.g., 142a) may include a non-polymeric material, such as, for example, a metal (e.g., aluminum, titanium, magnesium, an alloy thereof, and/or the like).

Referring additionally to FIGS. 5A and 5B, beam 14a can include a cover 198a. Cover 198a can be coupled to reinforcing structure 142a such that the cover overlies the reinforcing structure and provides an upper surface 202, opposite the reinforcing structure, for supporting a user's arm. By way of example, upper surface 202 can be smooth and/or textured, have a matte and/or gloss finish, be provided with padding, and/or the like. At least a portion of upper surface 202 can be defined by a thermoplastic elastomer, such as, for example, a polyolefin, a styrenic block copolymer, a polyurethane, a copolyester, a polyamide, and/or the like.

Cover 198a can have a lower surface 206, opposite upper surface 202, including one or more ribs 210. One or more ribs 210 can extend in a direction that is substantially parallel to a length 58 of beam 14a. When cover 198a is coupled to reinforcing structure 142a, one or more ribs 210 can contact the reinforcing structure. In these ways and others, one or more ribs 210 can increase a stiffness of cover 198a, facilitate positioning of the cover relative to reinforcing structure 142a, and/or the like.

Cover 198a can be configured for interlocking engagement with reinforcing structure 142a. For example, cover 198a can include one or more protrusions 214 extending from lower surface 206, each having a free end including a barb 218. Reinforcing structure 142a can include one or more ledges 220, each corresponding to barb 218 of one of one or more protrusions 214. During coupling of cover 198a to reinforcing structure 142a, as barb 218 of each protrusion 214 nears its corresponding ledge 220, the protrusion can be deflected by the reinforcing structure in a first direction, and, as the barb moves beyond the ledge, the barb can be urged, via flexibility of the protrusion, in a second direction that is opposite the first direction to engage the ledge, thereby coupling the cover to the reinforcing structure. In at least this way, cover 198a can be coupled to reinforcing structure 142a using minimal to no separate fasteners, thereby providing for reductions in manufacturing cost, manufacturing time, and/or weight. However, in other embodiments, a cover (e.g., 198a) can be coupled to a reinforcing structure (e.g., 142a) in any suitable fashion, such as, for example, via one or more fasteners (e.g., pin(s), rivet(s), bolt(s), screw(s), and/or the like), adhesive, integral formation (e.g., via molding of the cover with the reinforcing structure), and/or the like.

Cover 198a can include any suitable material, such as, for example, any polymeric material described above, whether or not fiber-filled, a metal (e.g., aluminum, titanium, magnesium, an alloy thereof, and/or the like), and/or the like. In some embodiments, a cover (e.g., 198a) can include one or more laminates (e.g., 50).

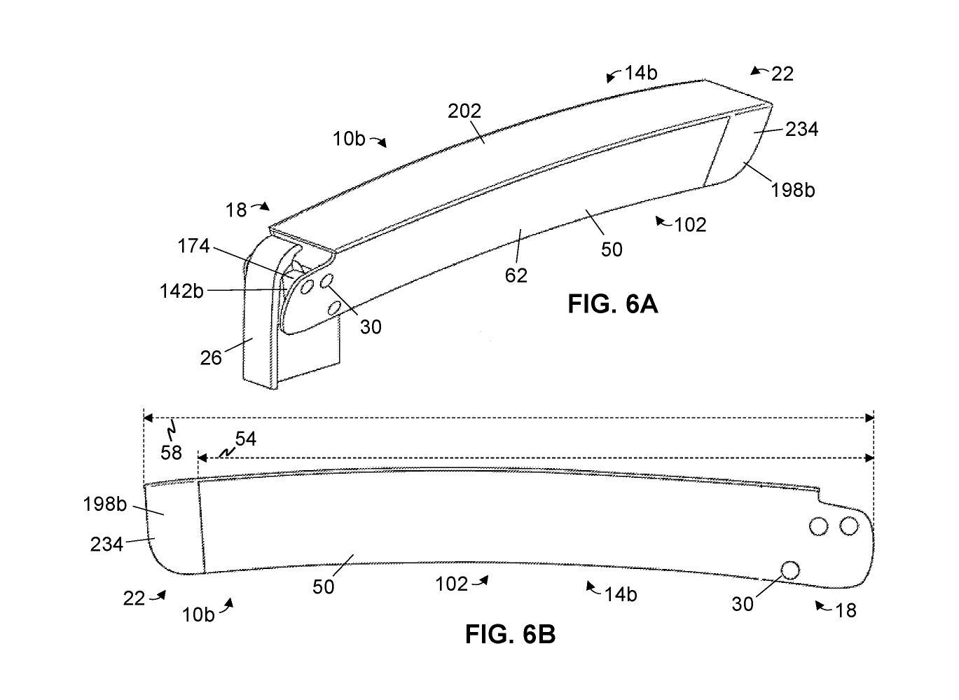

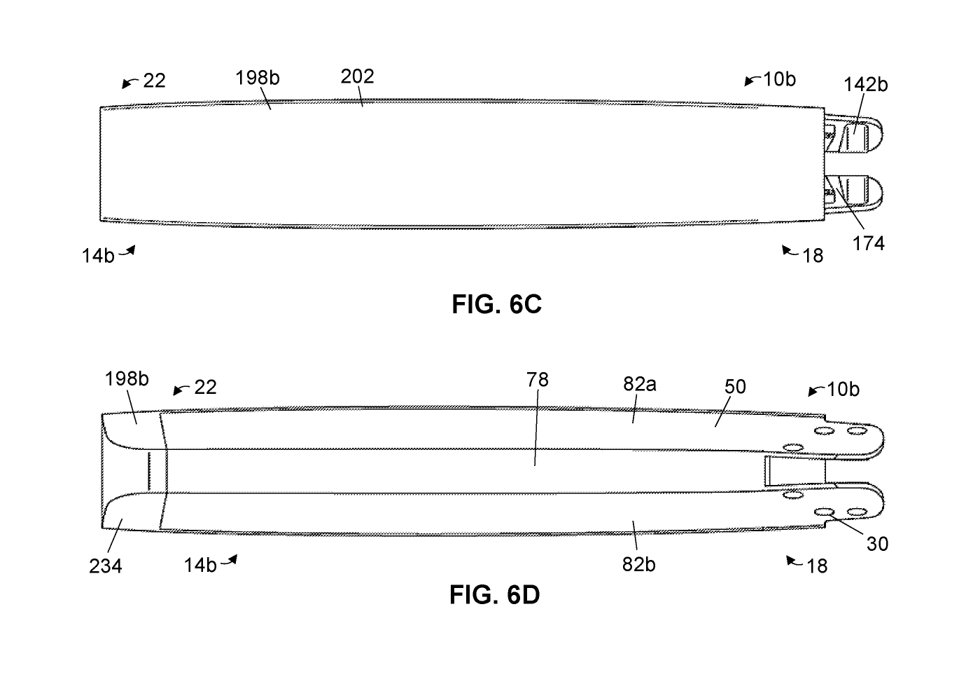

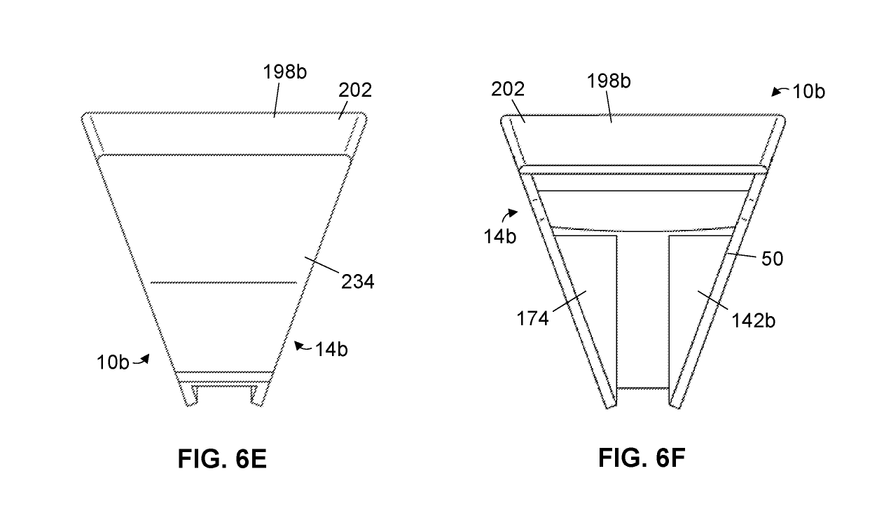

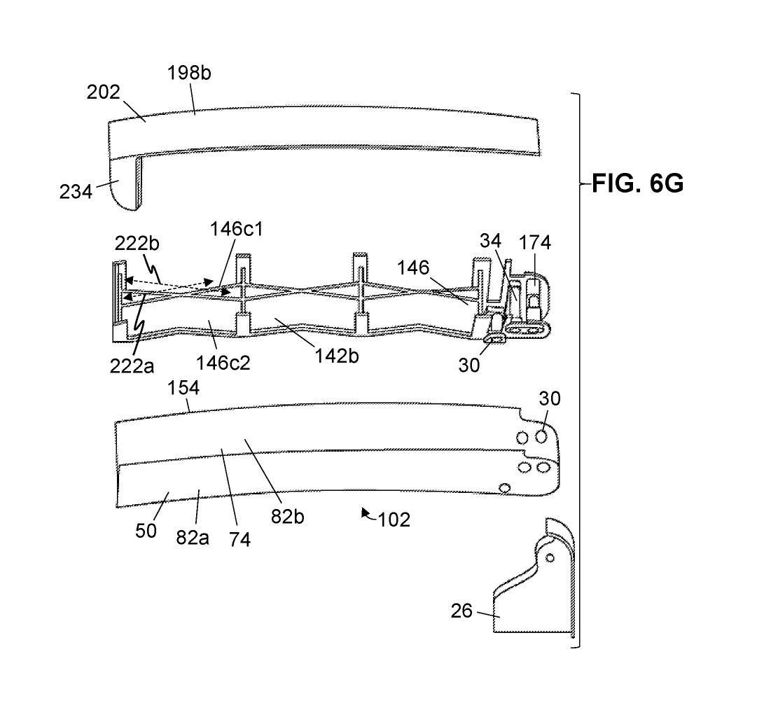

Referring now to FIGS. 6A-6G, shown is armrest 10b. Armrest 10b can be substantially similar to armrest 10a, with the primary exceptions described below. As with beam 14a, one or more laminates 50 of beam 14b can be disposed such that the one or more laminates increase a strength of beam 14b at the mounting location of the beam to a mount (e.g., 26); for example, one or more openings or slots 30 for receiving one or more fasteners 34 can extend through the one or more laminates and the one or more laminates can be disposed at any location where the beam contacts a mount (e.g., 26). Ribs 146 of reinforcing structure 142b can include a first rib 146c1 extending in a first direction 222a that is disposed at a non-perpendicular first angle relative to length 58 of beam 14b and a second rib 146c2 extending in a second direction 222b that is disposed at a non-perpendicular second angle relative to the length, where the first rib intersects the second rib, such that, for example, the first and second ribs cooperate to form a crisscross pattern. Adjacent sets of such intersecting ribs (e.g., 146c1 and 146c2) can be disposed along reinforcing structure 142b from first end 18 to second end 22.

When cover 198b is coupled to beam 14b, the cover can extend around one or more laminates 50 at second end 22. For example, cover 198b can include a nose portion 234 extending from lower surface 206 such that the lower surface is disposed above one or more laminates 50 at second end 22 and the nose portion is disposed in front of the one or more laminates at the second end. Cover 198b can abut and/or overlie at least a majority of outside edge 154 of one or more laminates 50. For example, nose portion 234 can abut and/or overlie at least a leading portion of outside edge 154 at second end 22, and lower surface 206 can abut and/or overlie other portions of the outside edge. In these ways and others, cover 198b can provide for advantages similar to those provided for by reinforcing structure 142a, described above.

As with cover 198a, cover 198b can be configured for interlocking engagement with reinforcing structure 142b. For example, reinforcing structure 142b can include one or more grooves or projections, each configured to receive or be received by a corresponding projection or groove of cover 198b. Such one or more grooves and/or one or more projections can be configured (e.g., by extending along reinforcing structure 142b and/or cover 198b in a direction substantially aligned with length 58 of beam 14b) such that cover 198b can be slidably received onto reinforcing structure 142b from second end 22.

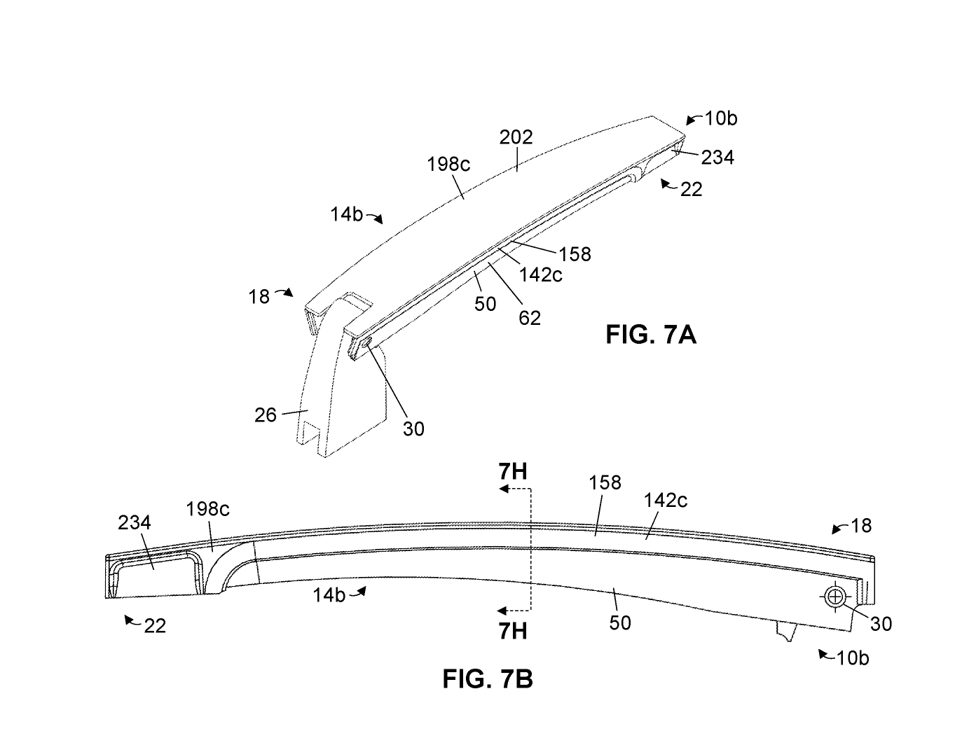

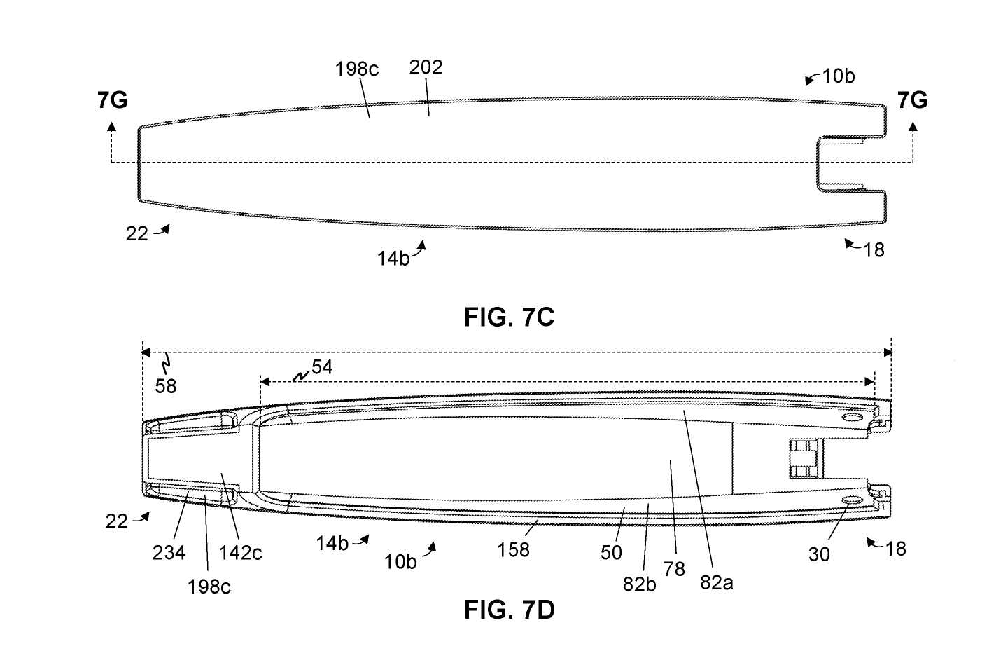

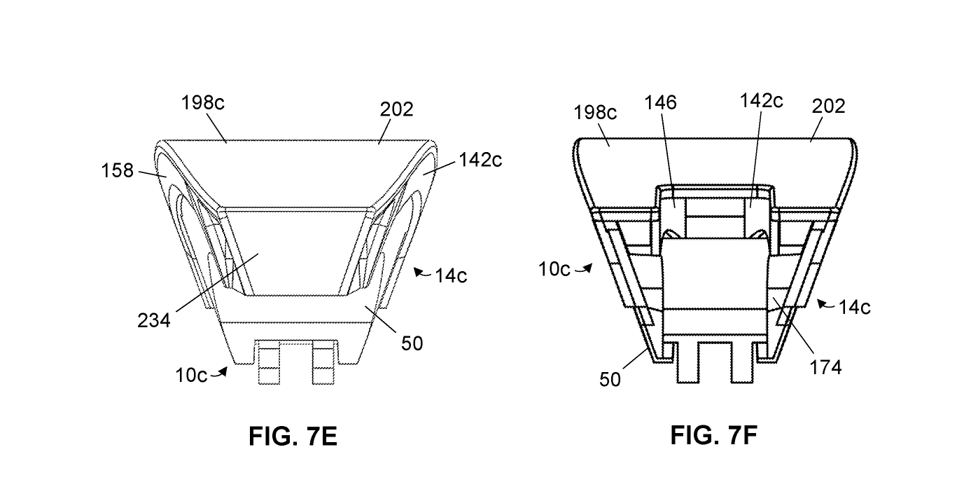

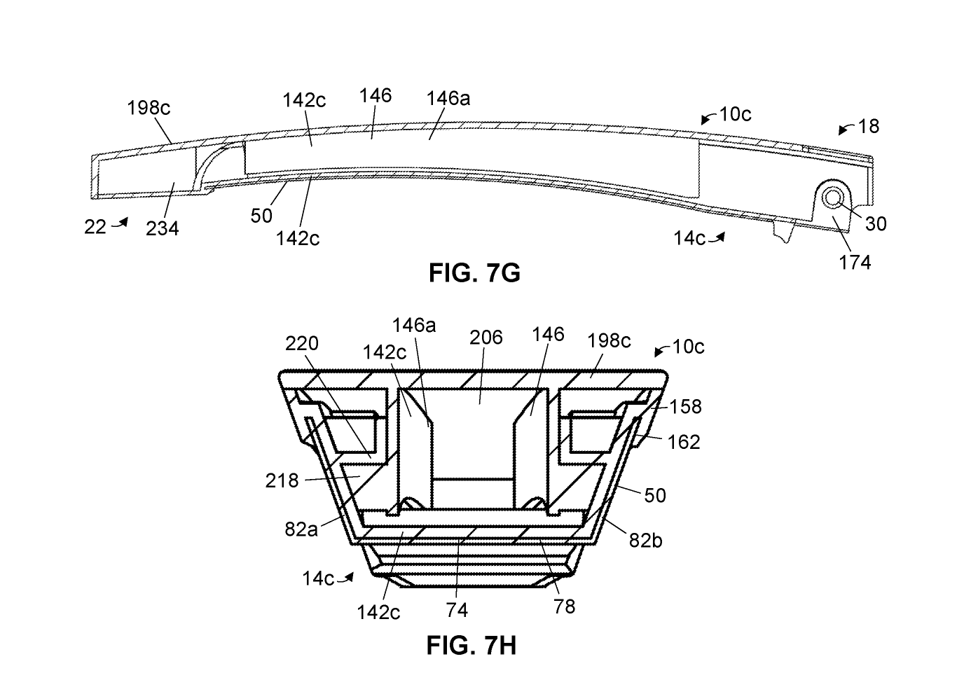

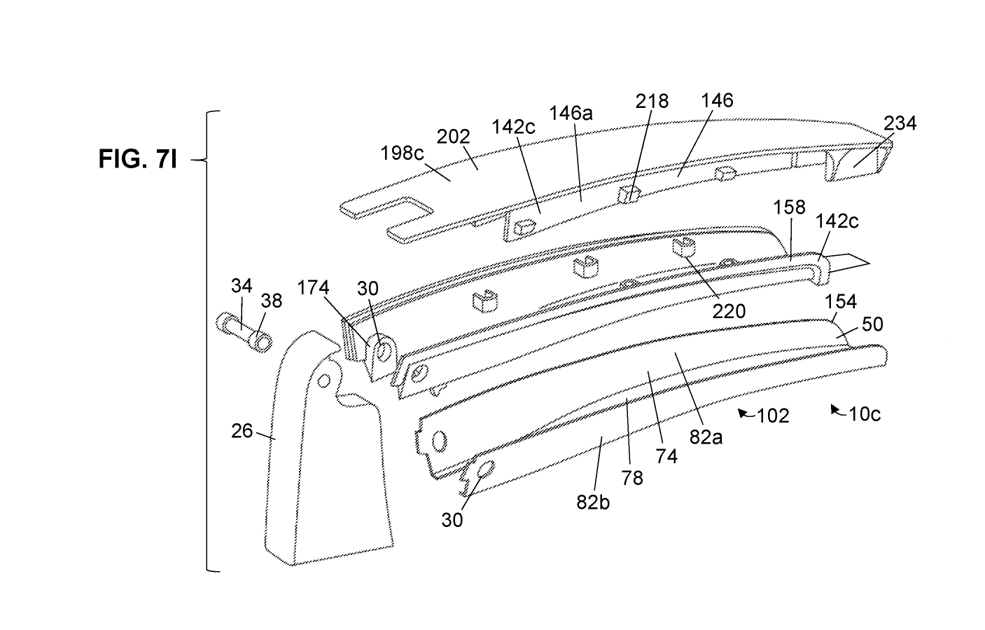

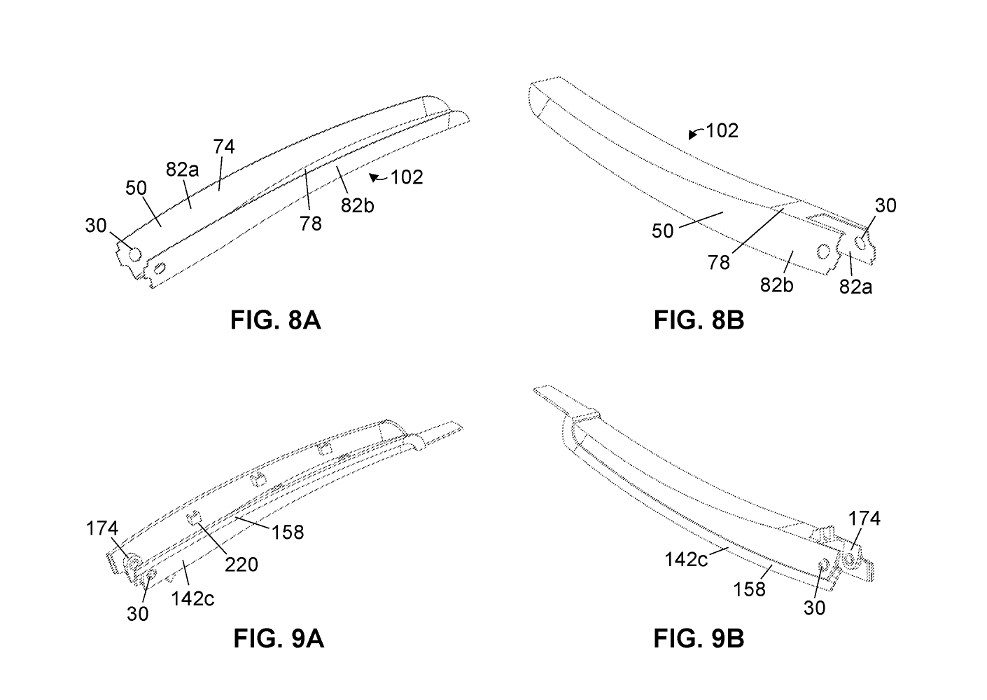

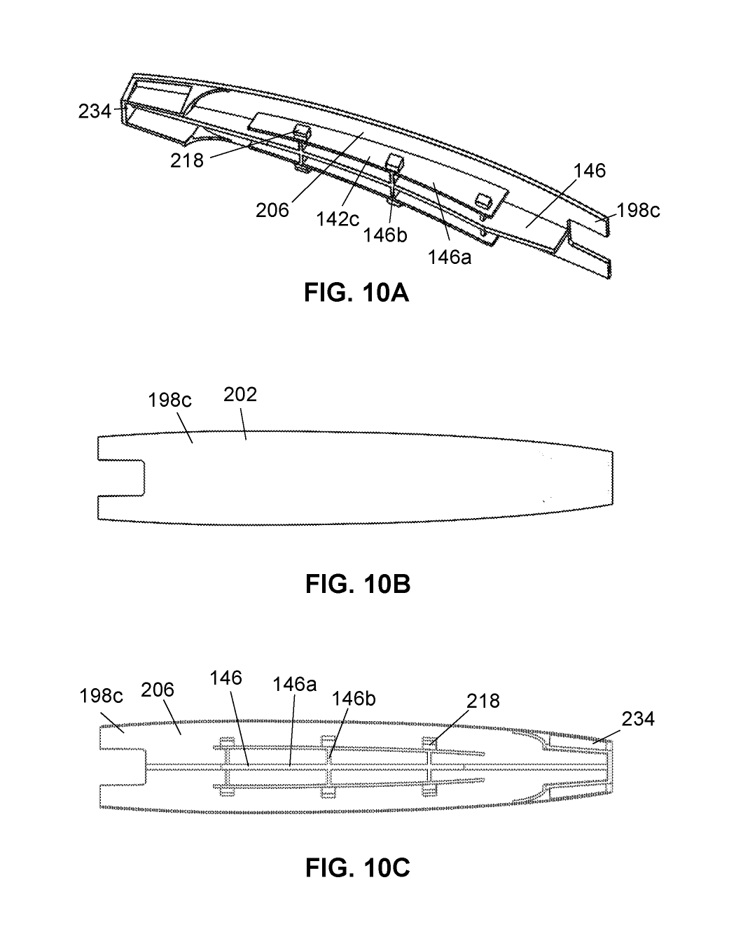

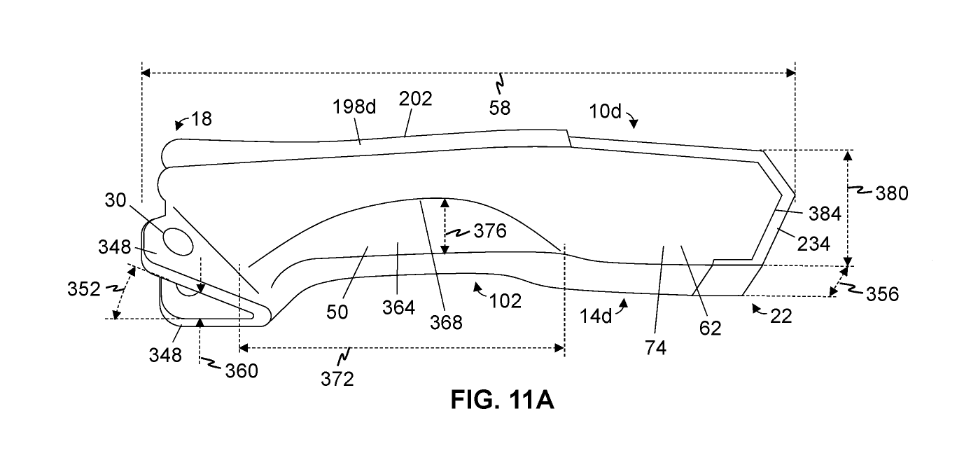

Referring now to FIGS. 7A-10C, shown is armrest 10c. Armrest 10c can be substantially similar to armrest 10a, with the primary exceptions described below. Cover 198c can include or be integrally formed with a portion of reinforcing structure 142c. For example, ribs 146 of reinforcing structure 142c, which can include one or more longitudinal ribs 146a and/or transverse ribs 146b, can be disposed on lower surface 206 of cover 198c (FIGS. 10A and 10C). Cover 198c can be coupled to a remaining portion of reinforcing structure 142c, such as a portion defining lip 158, similarly to as described above for armrest 10a, with one or more barbs 218 and corresponding ledges 220. One or more barbs 218 of cover 198c can be disposed on ribs 146 of the cover, which can be relatively stiff (e.g., when compared with protrusions 214 of cover 198a), thereby providing for a stronger connection between the cover and a remaining portion of reinforcing structure 142c. When cover 198c is coupled to a remaining portion of reinforcing structure 142c, portion(s) of the cover, such as, for example, ribs 146, barbs 218, and/or the like can contact the remaining portion of the reinforcing structure. In these ways and others, cover 198c can provide significant contributions to the load bearing capabilities of beam 14c, enhancing a torsional stiffness of the beam, reducing the need for overmolded features (e.g., in number and/or thickness) on one or more laminates 50 to meet design loadings, reducing a number, size, or thickness of the one or more laminates or laminae thereof required to meet design loadings, and/or the like.

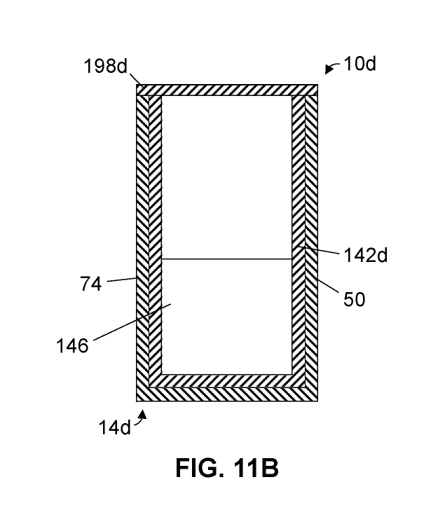

Referring now to FIGS. 11A and 11B, shown is armrest 10d. Armrest 10d can be substantially similar to armrest 10a, with the primary exceptions described below. Armrest 10d can include a pair of tabs 348 that extend from opposing sides of beam 14d for coupling the beam to a mount (e.g., 26). For example, each of tabs 348 can define an opening or slot 30 for receiving a fastener 34. In armrest 10d, tabs 348 are integrally formed with a portion of beam 14d (e.g., one or more laminates 50 and/or reinforcing structure 142d thereof); however, in other embodiments, such tabs (e.g., 348) can be coupled to a beam (e.g., 14d) in any suitable fashion, such as, for example, via one or more fasteners (e.g., pin(s), rivet(s), bolt(s), screw(s), and/or the like), adhesive, interlocking features of the tabs and the beam, and/or the like.

Tabs 348 can be angularly disposed relative to one another at an oblique angle 352. To illustrate, each of tabs 348 can extend from beam 14d in both a first direction that is from second end 22 toward first end 18 and a second, lateral direction (e.g., a direction aligned with a width 356 of the beam). To further illustrate, a distance 360 between tabs 348 (e.g., measured in a direction aligned with width 356) can increase in a direction from second end 22 toward first end 18. Angle 352, which can be measured between inner faces of the tabs, outer faces of the tabs, and/or the like, can be less than or substantially equal to any one of, or between any two of: 30, 35, 40, 45, 50, 55, 60, 65, 70, 75, 80, 85, 90, 95, 100, 105, 110, 115, 120, 125, 130, 135, 140, 145, or 150 degrees. In at least these ways, tabs 348 can provide for a stiffer and/or stronger connection of beam 14d to a mount (e.g., 26) (e.g., by defining a triangulated mounting structure).

For each of tabs 348, one or more laminates 50 can be disposed along and/or within the tab. For example, for each of tabs 348, opening or slot 30 can extend through one or more laminates 50. In this way, a strength of beam 14d at the mounting location of the beam to a mount (e.g., 26) can be increased.

In armrest 10d, outermost surface 62 of beam 14d can define a concavity 364 on a side of the beam that extends to the bottom of the beam. To illustrate, due to concavity 364, width 356 at the bottom of at least a portion of beam 14d can be reduced. An upper boundary 368 of concavity 364 can be arcuate, which can facilitate beam 14d in resisting torsion, carrying loads in a direction aligned with length 58 of the beam, and/or the like. Concavity 364 can have any suitable dimensions. For example, concavity 364 can have a length 372, measured in a direction aligned with length 58 of beam 14d, that is greater than or substantially equal to any one of, or between any two of: 25, 30, 35, 40, 45, 50, 55, 60, 65, 70, 75, 80, 85, 90, or 95% of length 58 of the beam. For further example, concavity 364 can have a height 376, measured in a direction aligned with a height 380 of beam 14d, that is greater than or substantially equal to any one of, or between any two of: 20, 25, 30, 35, 40, 45, 50, 55, 60, 65, 70, 75, or 80% of height 380 of the beam. Concavity 364 can, for example, provide additional space for a user of armrest 10d, reduce material cost of the armrest, and/or the like.

When cover 198d is coupled to beam 14d, the cover can extend around one or more laminates 50 and/or reinforcing structure 142d at second end 22. For example, cover 198d can include a nose portion 234 that defines a recess 384 configured to receive one or more laminates 50 and/or reinforcing structure 142d of beam 14d when the cover is coupled to the beam. To illustrate, due to recess 384, nose portion 234 can be disposed between one or more laminates 50 and/or reinforcing structure 142d and a bottom surface of beam 14d as well as between the one or more laminates and/or the reinforcing structure and a surface of the beam that is closest to second end 22.

Provided by way of illustration, beam 14d can have the following dimensions. Width 356 of beam 14d at its second end 22 can be greater than or substantially equal to any one of, or between any two of: 40, 42, 44, 46, 48, 50, 52, 54, 56, 58, or 60 mm (e.g., approximately 50 mm). Height 380 of beam 14d at its second end 22 can be greater than or substantially equal to any one of, or between any two of: 90, 95, 100, 105, 110, 115, 120, 125, or 130 mm (e.g., approximately 110 mm). Length 58 of beam 14d can be greater than or substantially equal to any one of, or between any two of: 380, 385, 390, 395, 400, 405, 410, 415, 420, 425, 430, 435, 440, 445, 450, 455, 460, 465, 470, 475, or 480 mm (e.g., approximately 430 mm).

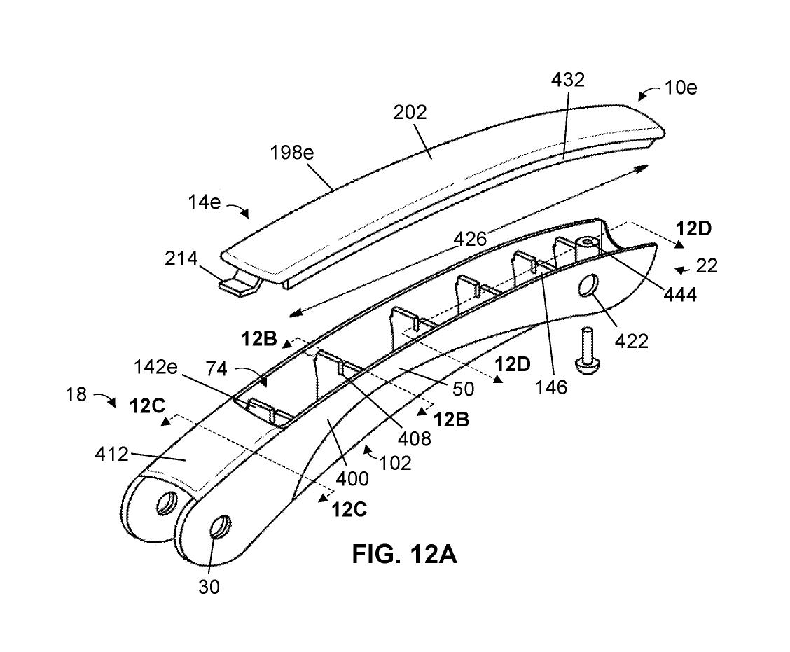

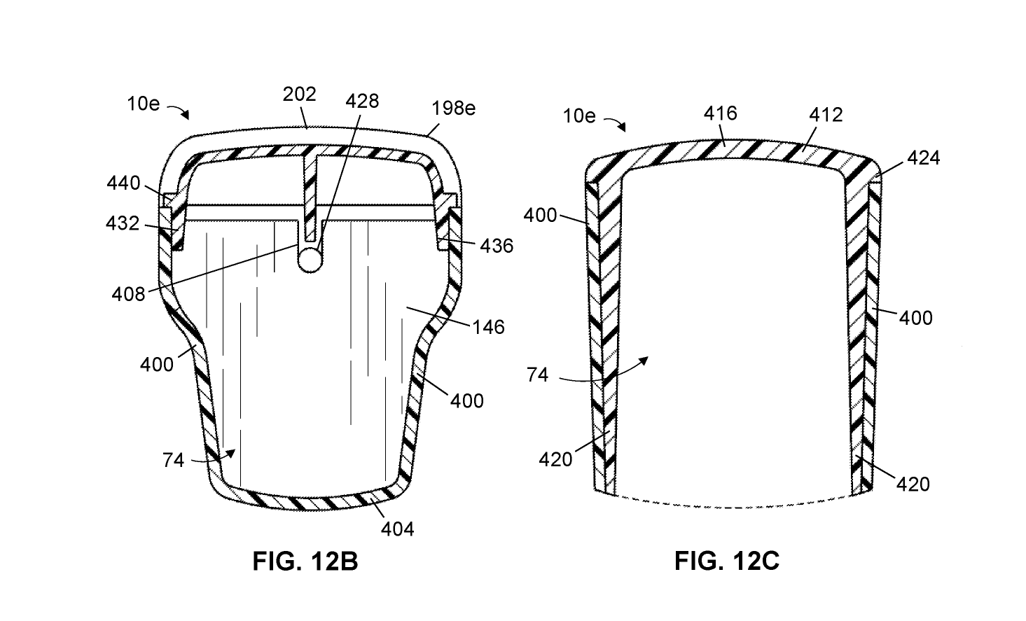

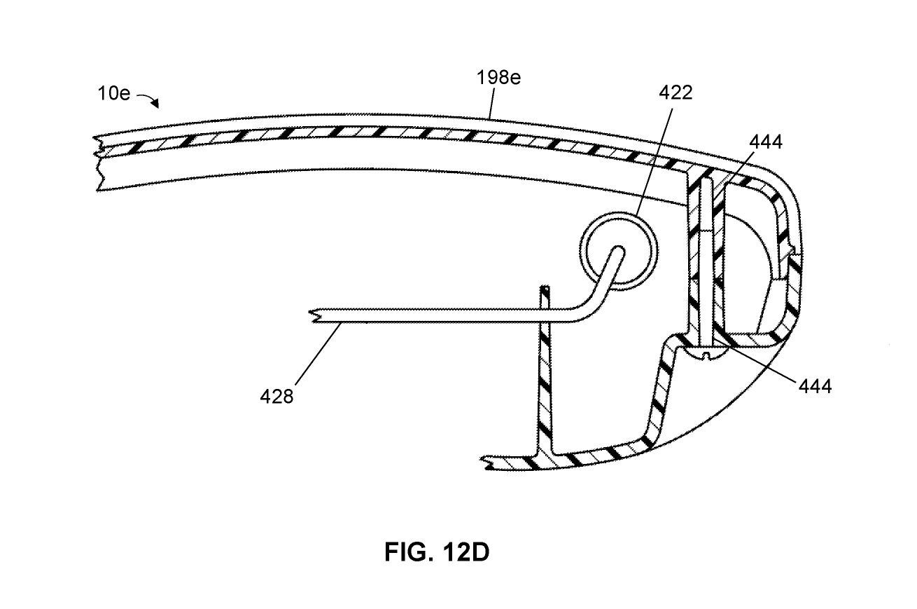

Referring now to FIGS. 12A-12D, shown is a fifth embodiment 10e of the present armrests. Armrest 10e can be substantially similar to armrest 10a, with the primary exceptions described below. In this embodiment, beam 14e includes a channel 74 defined by frame sidewalls 400 and a frame bottom wall 404. As with beam 14a, beam 14e includes one or more ribs 146 that extend into and/or across channel 74. Rib(s) 146 can extend from frame bottom wall 404 and/or between frame sidewalls 400. Frame sidewalls 400, frame bottom wall 404, and rib(s) 146 can be defined by a reinforcing structure 142e of beam 14e and/or one or more laminates 50 of the beam.

Beam 14e can include a hinge member 412 configured to be at least partially disposed within channel 74 such that the hinge member extends between frame sidewalls 400. As shown, hinge member 412 can be disposed closer to first end 18 of beam 14e than second end 22 of the beam. Hinge member 412 can include a hinge top wall 416 and hinge sidewalls 420 that extend from the hinge top wall (FIG. 12C). Hinge sidewalls 420 can contact frame sidewalls 400 when hinge member 412 is disposed within channel 74. Hinge member 412 can include a shoulder 424 that contacts an upper edge of frame sidewalls 400 when the hinge member is disposed within channel 74. In some embodiments, a hinge member (e.g., 412) is unitary with at least a portion of a frame sidewall (e.g., 400) and/or a frame bottom wall (e.g., 404). In beam 14e, one or more openings or slots 30 can be defined through frame sidewalls 400 and/or hinge sidewalls 420.

Beam 14e can define one or more openings or slots 422 configured to receive one or more buttons, knobs, and/or electronic components; such button(s), knob(s), and/or electronic component(s) can, for example, allow a user to adjust their seat. To illustrate, such a button, knob, and/or electronic component can actuate a hinge release cable 428 (FIG. 12D) to permit movement of beam 14e between a deployed position (e.g., FIG. 13A) and a stowed position (e.g., 13B). Hinge release cable 428 can extend through one or more recesses 408 defined by rib(s) 146.

Armrest 10e can include a cover 198e. Cover 198e can be substantially similar to cover 198a, with the primary exceptions described below. As with cover 198a, cover 198e includes an upper surface 202. Cover 198e can be configured to be coupled to hinge member 412, frame sidewalls 400, and/or frame bottom wall 404 such that the cover overlies channel 74 and provides upper surface 202, opposite the frame bottom wall, for supporting a user's arm. Cover 198e can include a rib 432 that extends along a length 426 of the cover. When cover 198e is coupled to beam 14e, rib 432 can contact frame sidewalls 400, be received by recess(es) 436 that are at least partially defined by rib(s) 146, and/or the like. Cover 198e can include a shoulder 440 configured to contact an upper edge of frame sidewalls 400 such that, for example, the cover is supported by the frame sidewalls when the cover is coupled to beam 14e.

Cover 198e can include one or more protrusions (e.g., tab(s)) 214 configured to secure cover 198e to hinge member 412 and/or frame sidewalls 400. Cover 198e can be secured to frame sidewalls 400 and/or frame bottom wall 404 via one or more fasteners (e.g., pin(s), rivet(s), bolt(s), screw(s), and/or the like). To illustrate, cover 198e can include a boss 444 that aligns with a boss 444 extending from frame sidewalls 400 and/or frame bottom wall 404 when the cover is coupled to beam 14e such that a fastener can be received by the bosses to secure the cover to the beam.

As with beam 14a, beam 14e can include one or more laminates 50. For example, one or more laminates 50 can be disposed on and/or within frame sidewalls 400, frame bottom sidewall 404, hinge member 412, and/or cover 198e.

While in armrests 10a-10e, one or more laminates 50 of each of beams 14a-14e define a channel 74 that is open toward a top of the beam, in other embodiments, one or more laminates can define a channel that is open toward a bottom of a beam.

Referring now to FIGS. 13A and 13B, shown is a representative armrest 10, which can be an armrest 10a, 10b, 10c, 10d or 10e, including an elongated beam 14 pivotally coupled to a mount 26. As shown, beam 14 can be movable relative to mount 26 (e.g., generally in a direction indicated by arrow 246) between a stowed position (FIG. 13B) and a deployed position (FIG. 13A) in which the beam extends further from the mount in a horizontal direction (e.g., generally indicated by arrow 250) than when the beam is in the stowed position.

One or more support elements 254 (e.g., strut(s), linkage(s), bar(s), beam(s), and/or the like) can be coupled between mount 26 and beam 14 such that the one or more support elements can support the beam relative to the mount when the beam is in the deployed position. For example, one or more support elements 254 can be configured to physically limit movement of beam 14 relative to mount 26 beyond the deployed position.

To illustrate, one or more support elements 254 can be pivotally coupled to mount 26 and slidably coupled to beam 14. As beam 14 moves relative to mount 26 toward the deployed position, one or more support elements 254 can slide relative to the beam and pivot relative to the mount, and, once the beam reaches the deployed position, further sliding of the one or more support elements relative to the beam and/or further pivoting of the one or more support elements relative to the mount can be physically limited (e.g., by the beam and/or mount, respectively), thereby limiting further movement of the beam relative to the mount and supporting the beam in the deployed position via the one or more support elements. Beam 14, when supported in the deployed position by one or more support elements 254, can be characterized as simply supported. Such support elements (e.g., 254) may be curved (e.g., as shown) or straight. Such support elements (e.g., 254) can include hinges, extensible portions, and/or the like. One or more support elements 254 can reduce a number and/or size of laminates (e.g., 50) and/or laminae, an amount of reinforcing structure (e.g., 142a, 142b, 142c, 142d, or 142e), and/or the like required for an armrest (e.g., 10a, 10b, 10c, 10d, or 10e) to meet design loading requirements, thereby providing for reductions in weight, manufacturing costs, and/or the like.

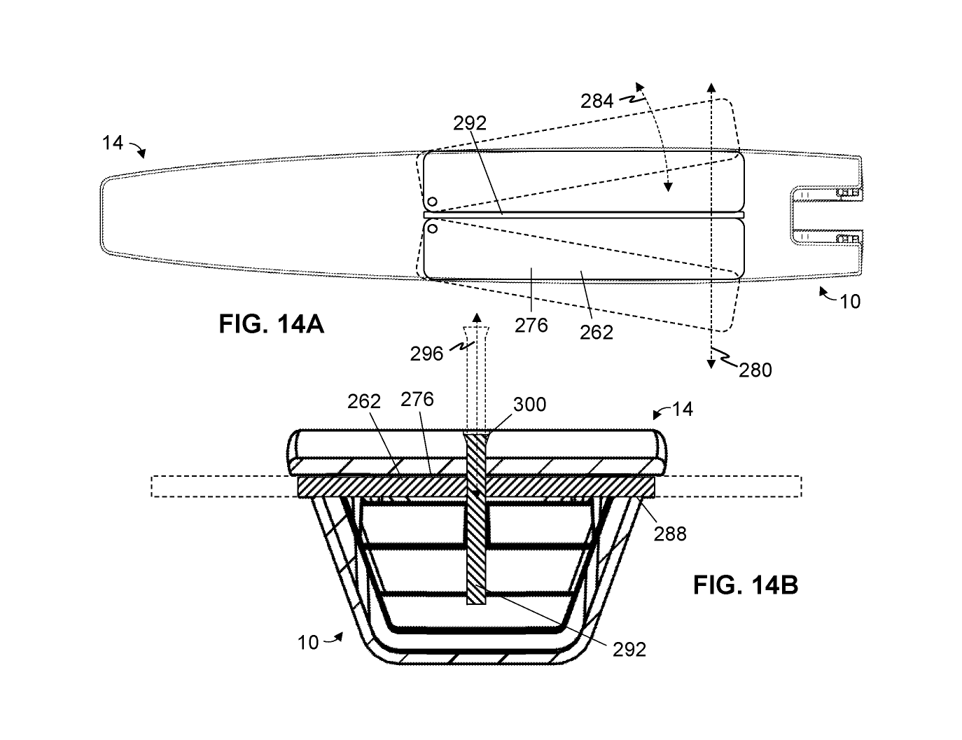

Referring now to FIGS. 14A and 14B, shown is a representative armrest 10, which can be an armrest 10a, 10b, 10c, 10d, or 10e, including an elongated beam 14. Armrest 10 can include one or more elbow rests 262 that can extend horizontally from beam 14, each having an upper surface 276 for supporting a user's arm. One or more elbow rests 262 can be thin or plate-like. Upper surface 270 of one or more elbow rests 262 can be flat or curved, such as, for example, to correspond to a contour of a cover (e.g., 198a, 198b, 198c, 198d, or 198e) of armrest 10. One or more elbow rests 262 can be retractable. For example, one or more elbow rests 262 can be movably coupled to beam 14 such that the one or more elbow rests are movable relative to the beam between a stowed position (e.g., indicated by solid lines in FIGS. 14A and 14B) and a deployed position (e.g., indicated by dashed lines in FIGS. 14A and 14B) in which the one or more elbow rests extend further from the beam in a horizontal direction (e.g., generally indicated by arrow 280) than when in the stowed position. As shown, one or more elbow rests 262 can be pivotally coupled to beam 14 such that the one or more elbow rests are rotatable relative to the beam (e.g., generally in a direction indicated by arrow 284) between the stowed position and the deployed position. Such rotation of one or more elbow rests 262 relative to beam 14 can be in a substantially horizontal plane.

At least a portion of one or more elbow rests 262 may be retractable into beam 14. For example, a portion of at least one of one or more elbow rests 262 that is disposed outside of beam 14 when the elbow rest is in the deployed position can be disposed within the beam when the elbow rest is in the stowed position. Such retractability of one or more elbow rests 262 into beam 14 can be facilitated by one or more openings or slots 288 defined by the beam (e.g., through a cover 198a, 198b, 198c, 198d, or 198e, a reinforcing structure 142a 142b, 142c, 142d, or 142e, one or more laminates 50, and/or the like), each configured to receive a respective one of the one or more elbow rests.

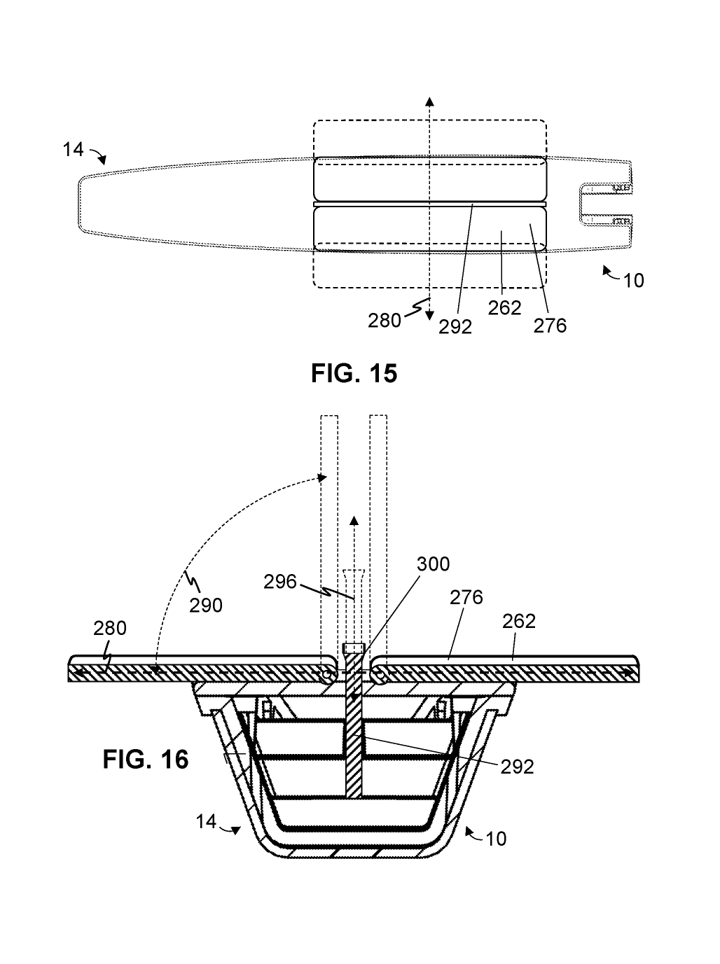

FIG. 15 depicts a configuration of armrest 10 and one or more elbow rests 262 in which the one or more elbow rests can be slidably coupled to beam 14. FIG. 16 depicts a configuration of armrest 10 and one or more elbow rests 262 in which the one or more elbow rests can be pivotally coupled to beam 14 and rotatable relative to the beam (e.g., generally in a direction indicated by arrow 290) in a substantially vertical plane between the stowed position and the deployed position.

Armrest 10 can include a divider 292 that can extend vertically from beam 14 to divide the beam lengthwise, providing for increased comfort and privacy to users that may have to share the armrest. Divider 292 can be thin or plate-like and generally planar. Divider 292 can be movably (e.g., slidably or pivotally) coupled to beam 14 such that the divider is movable relative to the beam between a stowed position (e.g., indicated by solid lines in FIG. 14B) and a deployed position (e.g., indicated by dashed lines in FIG. 14B) in which the divider extends further from the beam in a vertical direction (e.g., generally indicated by arrow 296) than when in the stowed position. Similarly to as described above for one or more elbow rests 262, divider 292 can be retractable into beam 14. Divider 292, when in the stowed position, can protrude from beam 14 to allow a user to access divider to move the divider toward the deployed position. Such access can be facilitated by an enlarged end portion 300 of the divider.

Some embodiments of the present methods for forming an armrest (e.g., 10a, 10b, 10c, 10d, 10e, and/or the like) comprise overmolding a plastic material (e.g., any polymeric material described above) onto one or more laminates (e.g., 50) to form an elongated beam (e.g., 14a, 14b, 14c, and/or the like) extending between a first end (e.g., 18) and a second end (e.g., 22), each of the one or more laminates including a plurality of fibers (e.g., 106) dispersed within a matrix material (e.g., 110), where the overmolding is performed such that the one or more laminates define an arched channel (e.g., as shown above for one or more laminates 50 of armrests 10a, 10b, 10c, 10d, and 10e) extending between the first and second ends, and the plastic material defines a reinforcing structure (e.g., 142a, 142b, 142c, 142d, 142e, and/or the like) including a plurality of ribs (e.g., 146), each extending into the channel.

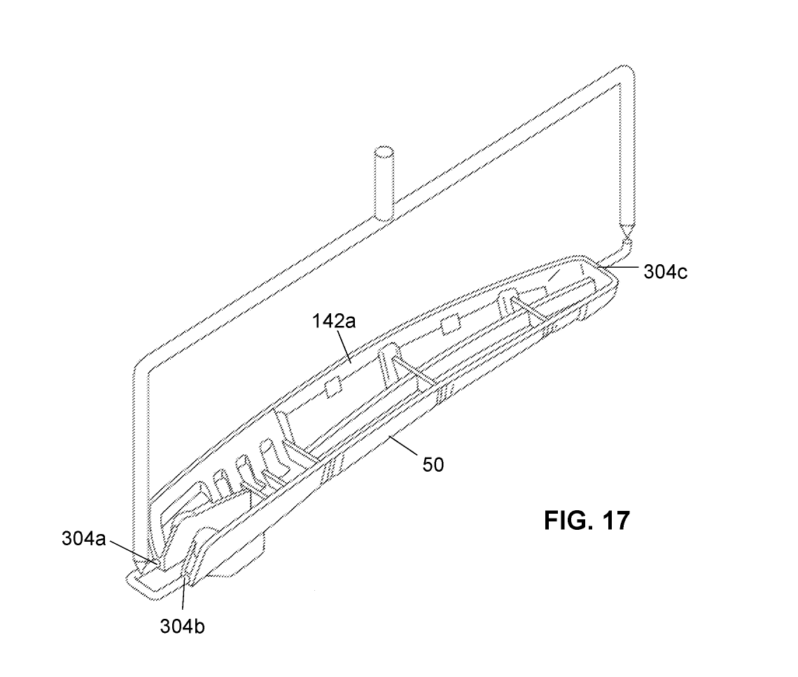

For example, FIG. 17 illustrates one or more steps of an injection molding process, which may be suitable for use in some embodiments of the present methods. As shown, injection molding material can be provided to longitudinally opposing ends of a mold cavity configured to overmold a reinforcing structure 142a onto one or more laminates 50 (e.g., via gates 304a and 304b at a first end and at gate 304c at a second end that is opposite the first end). Such a configuration can encourage structural uniformity of the molded reinforcement structure, mitigate undesirable movement of the one or more laminates during the molding process, and/or, if using a fiber-filled injection molding material, alignment of fibers of the fiber-filled injection molding material along the longitudinal axis of the molded reinforcement structure.

Some embodiments of the present kits comprise one or more laminates (e.g., 50), one or more laminae, and/or one or more arrangements of fibers. Such laminate(s), lamina(e), or arrangement(s) of fibers can be pre-cut into suitable shape(s) (e.g., a shape of one or more laminates 50 when flattened), pre-assembled, and/or pre-impregnated to facilitate manufacture of armrests (e.g., 10a, 10b, 10c, 10d, 10e, and/or the like).

### EXAMPLES

The present invention will be described in greater detail by way of specific examples. The following examples are offered for illustrative purposes only and are not intended to limit the invention in any manner. Those of skill in the art will readily recognize a variety of noncritical parameters that can be changed or modified to yield essentially the same results.

### Example 1

### Simulated Design Loadings on Armrests of the Present Disclosure

Structural analysis software was used to evaluate armrest 10a under two exemplary design loadings. For each design loading, a force 316 was applied to beam 14a of the armrest via a rigid load applicator 312 while holding a bottom surface of mount 26 fixed. Stress in both reinforcing structure 142a and one or more laminates 50 was calculated.

A. Design Loading 1: 300 Pound (lbf) Downward Force

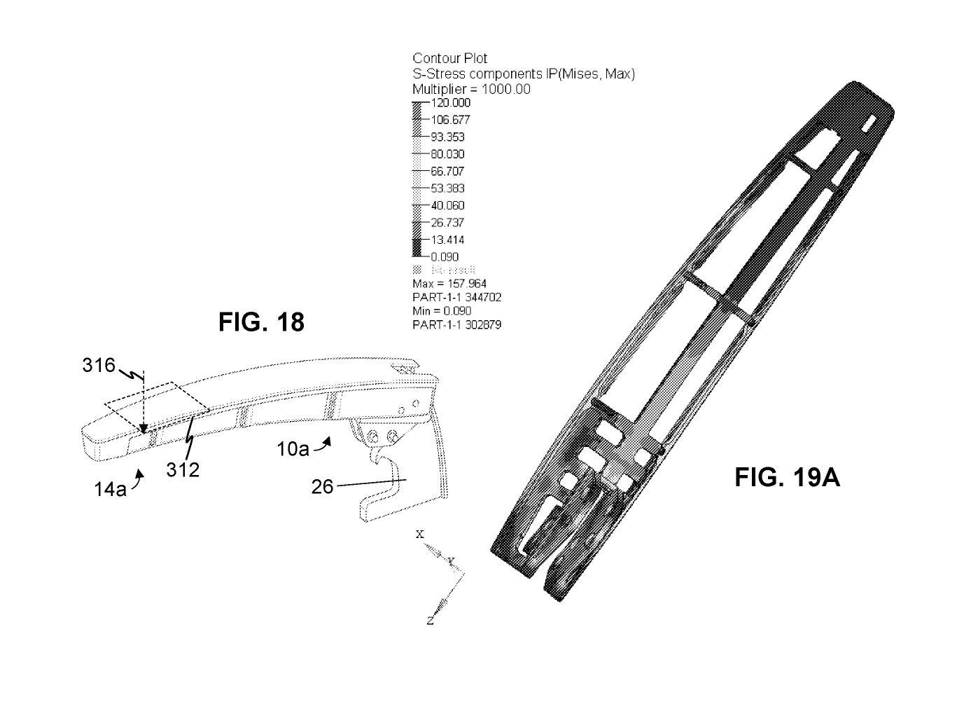

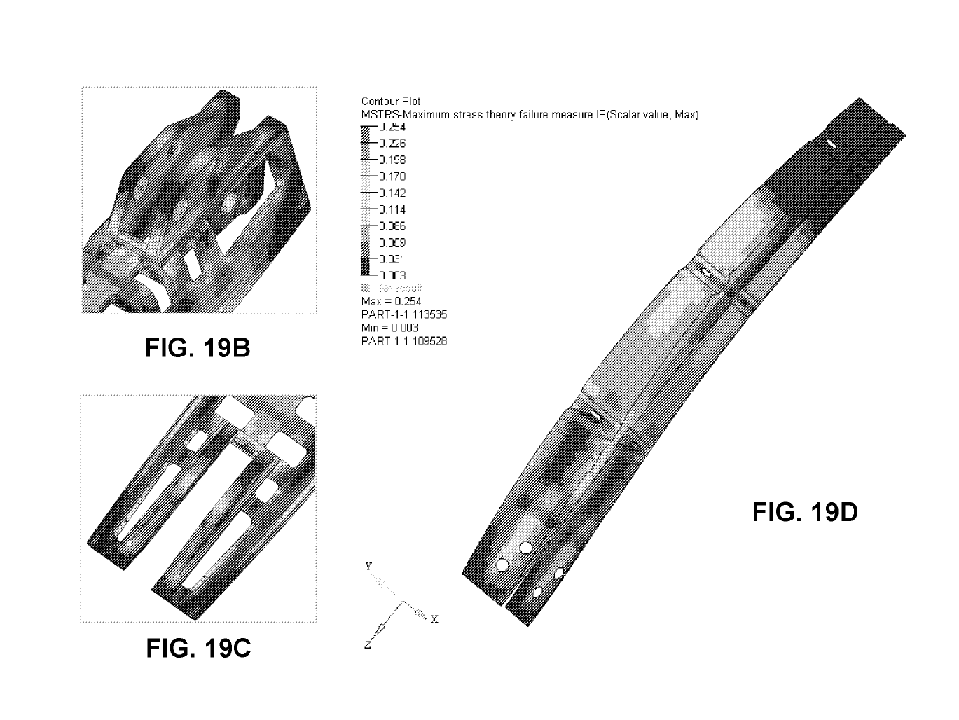

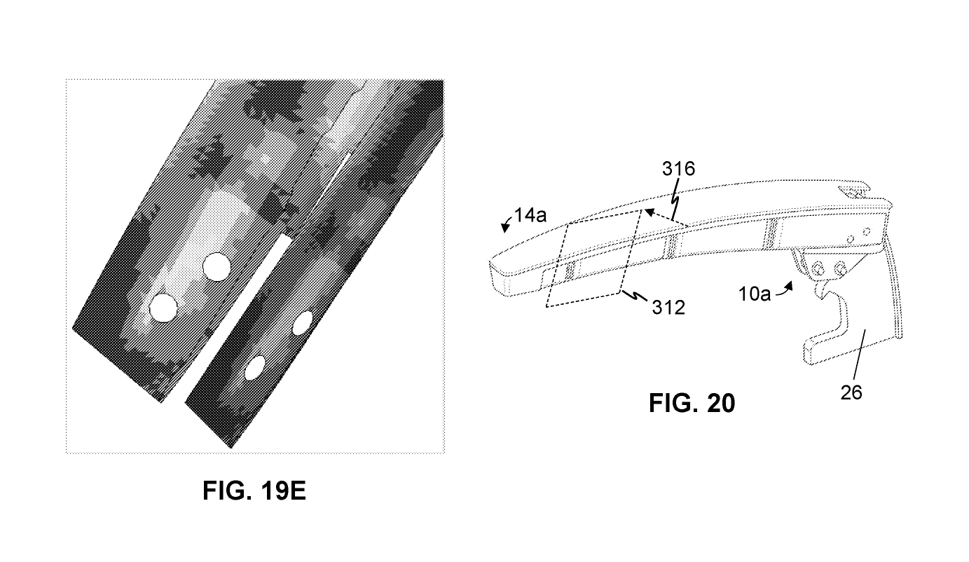

A 300 lbf downward force 316 was applied to beam 14a via rigid load applicator 312 (FIG. 18). FIGS. 19A-19C depict resulting stresses in reinforcing structure 142a, for which a target or failure stress was set at 240 megapascals (MPa). As shown, a maximum stress in reinforcing structure 142a was 158 MPa, which was well below the target or failure stress. FIGS. 19D and 19E depict resulting stresses in one or more laminates 50, normalized by a target or failure stress for the one or more laminates such that a value of 1 indicates that the target or failure stress was reached. As shown, a normalized maximum stress in one or more laminates 50 was 0.25 (25% of the target or failure stress).

### B. Design Loading 2: 200 lbf Sideways Force

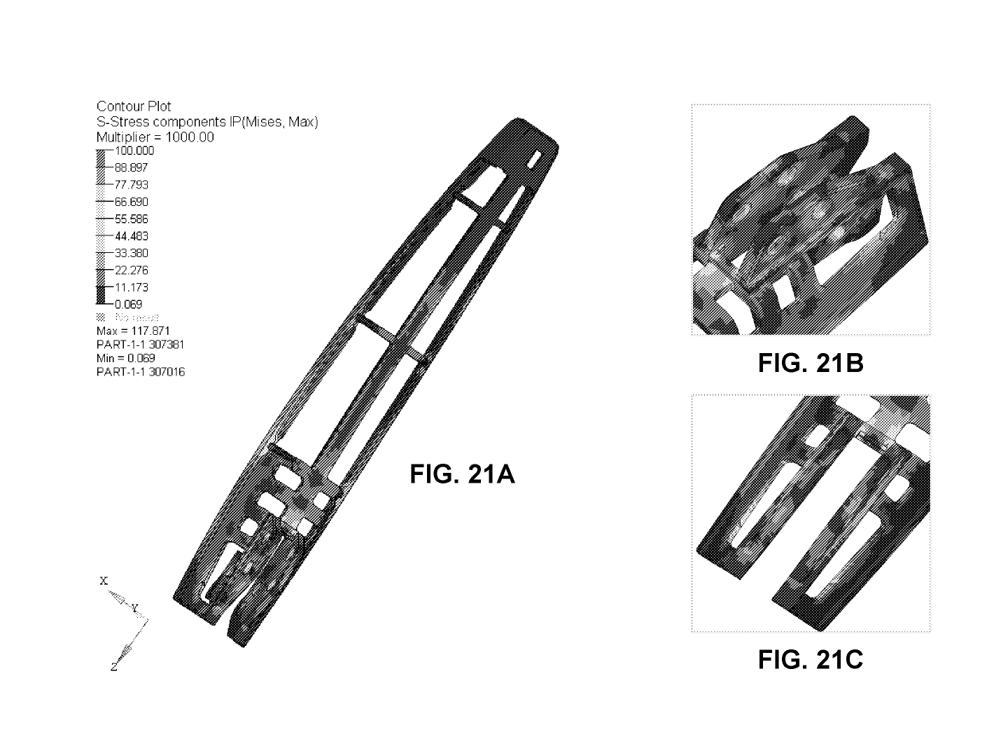

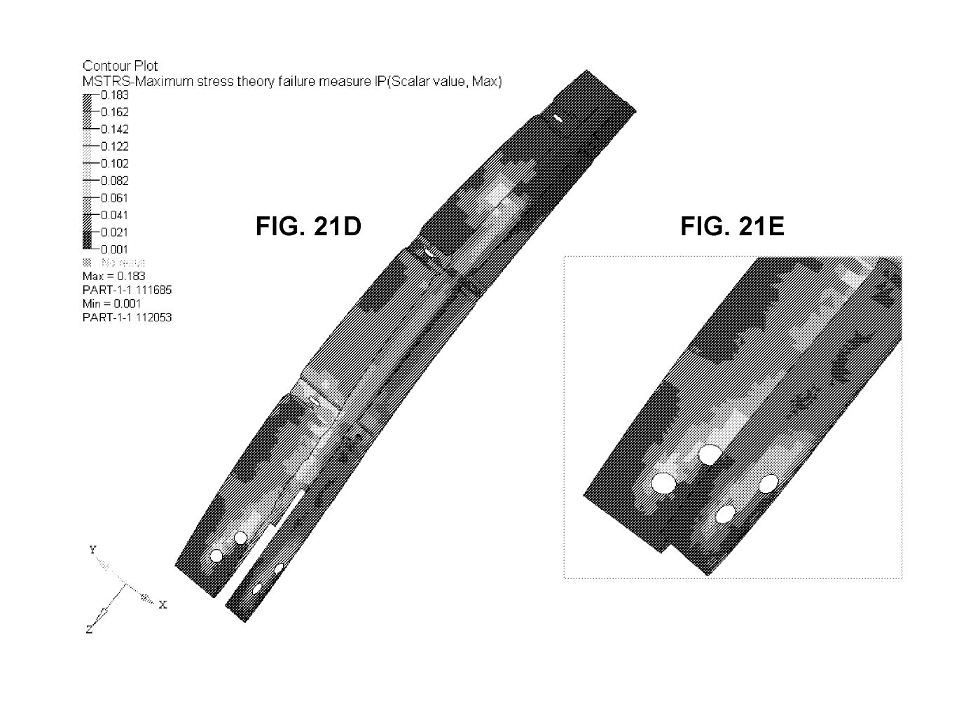

A 200 lbf sideways force 316 was applied to beam 14a via rigid load applicator 312 (FIG. 20). FIGS. 21A-21C depict resulting stresses in reinforcing structure 142a. As shown, a maximum stress in reinforcing structure 142a was 118 MPa—well below the target or failure stress for the reinforcing structure. FIGS. 21D and 21E depict resulting stresses in one or more laminates 50, for which a normalized maximum stress was 0.18 (18% of the target or failure stress for the one or more laminates).

### Example 2

### Structural Testing of Armrests of the Present Disclosure

Samples of beam 14a were made, each without cover 198a. The samples each had a reinforcing structure 142a including either a glass fiber-filled polyetherimide material (“Material 1”) or a carbon fiber-filled polyetherimide material (“Material 2”) and one or more laminates 50 including carbon fibers. The samples were molded using various mold temperatures and cycle times (FIG. 23).

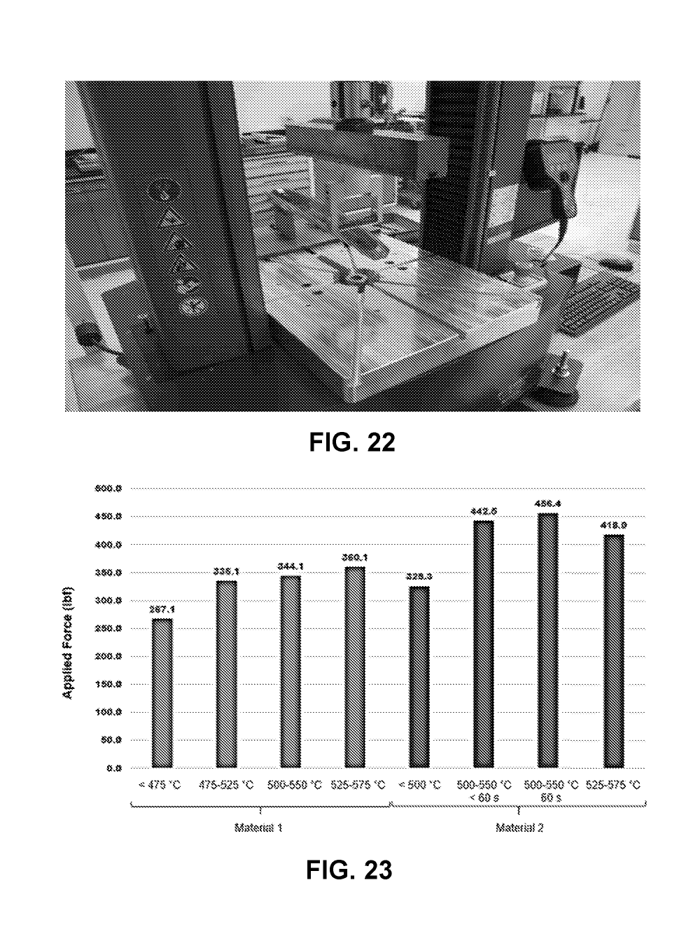

Using the test fixture depicted in FIG. 22, each of the samples was fixed to a mount 26 at its first end 18 and was subjected to a downward force, applied to the top of the sample nearer its second end 22 than its first end 18, that was increased until the sample failed. FIG. 23 depicts, for each sample, the force at which the sample failed. In general, samples including Material 2 were stronger (withstood a larger amount of force before failing) than samples including Material 1. Also, increasing mold temperature and increasing cycle time each had a positive effect on sample strength. This may be due to higher mold temperatures and/or higher cycle times providing for a stronger bond between one or more laminates 50 of a sample and reinforcing structure 142a of the sample.

### Example 3

### Structural Testing of Armrests of the Present Disclosure

Armrest 10a was structurally tested using both structural analysis software as well as the test fixture depicted in FIG. 22. For both tests, beam 14a of the armrest was fixed to a mount 26 at its first end 18 and was subjected to an increasing downward force, applied to the top of the beam nearer its second end 22 than its first end 18. Reinforcing structure 142a of beam 14a included Material 2, and one or more laminates 50 of the beam included carbon fibers. The results of the software-based test are shown in TABLE 1.

TABLE 1
Results of Software-based Structural Testing of Armrest 10a

| | | Normalized | Maximum | Middle | Minimum |
|---|---|---|---|---|---|
| | Failure | Maximum | Principal | Principal | Principal |
| | Stress in | Stress in | Stress in | Stress in | Stress in |
| Force at | Beam 14a | Laminate(s) | Laminate(s) | Laminate(s) | Laminate(s) |
| Failure (lbf) | (MPa) | 50 | 50 (MPa) | 50 (MPa) | 50 (MPa) |
| 473 | 242 | .66 | 407.12 | 115.2 | 268 |

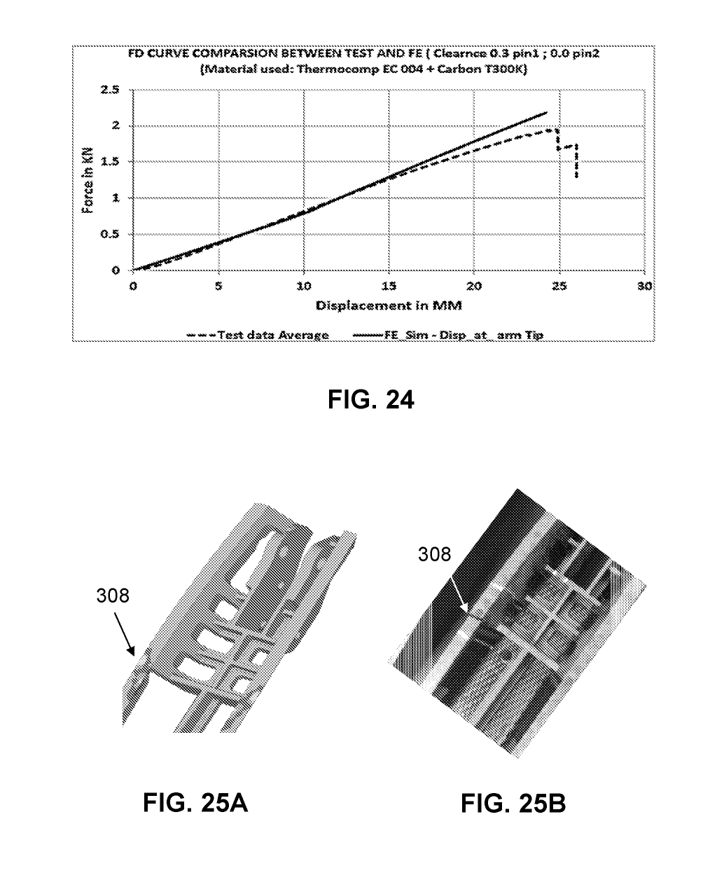

FIG. 24 depicts beam 14a displacement vs. applied force for both tests, and FIGS. 25A and 25B depict locations of failure 308 of the beam determined by the software-based test and the actual test, respectively.

### Example 4

### Topology Optimization of Armrests of the Present Disclosure

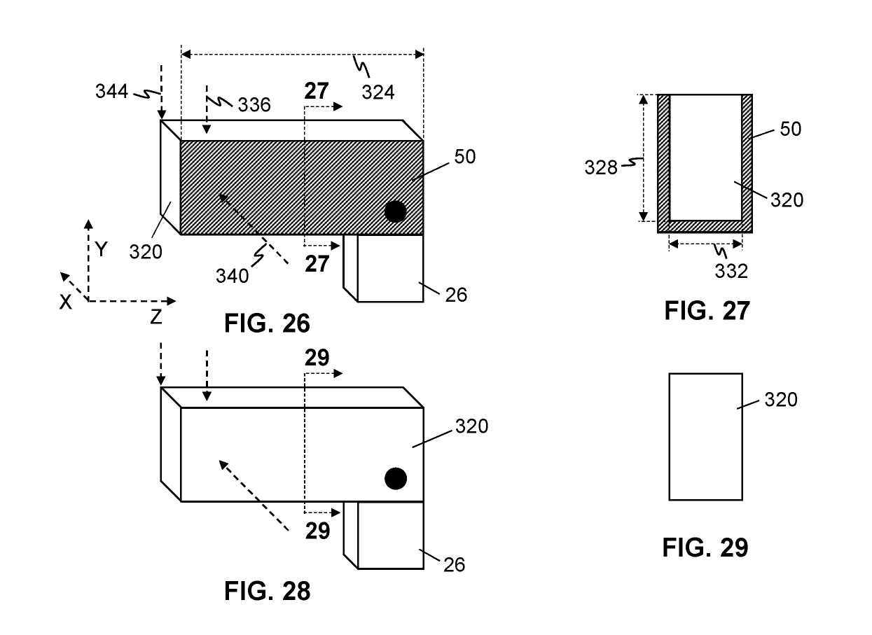

Topology optimization software was used to identify suitable configurations for a reinforcing structure (e.g., 142a) of an armrest. Referring now to FIGS. 26 and 27, a design volume 320 corresponding to an armrest was selected. In this example, design volume 320 had a length 324 of 430 mm, a height 328 of 110 mm, and a width 332 of 50 mm. Reinforcing structures generated within design volume 320 were each modeled as including Material 2 and were subject to the following constraints and loads: (1) a fixed condition in all degrees of freedom at a first end of the design volume; (2) a downwards force 336 of 300 lbf, a sideways force 340 of 200 lbf, and a twisting force 344 of 100 lbf, each applied to the reinforcing structure closer to a second end of the design volume than to the first end; and (3) a maximum displacement of 15 mm. In this example, the objective was to minimize weighted compliance.

Two scenarios were analyzed—a first scenario in which design volume 320 was bounded on three of its sides by one or more laminates 50 (FIGS. 26 and 27) such that the one or more laminates provided support to reinforcing structures generated within the design volume, and a second scenario without the presence of such laminate(s) (FIGS. 28 and 29). In the first scenario, the topology optimization software was unable to provide a feasible solution, which may be due to the significant support provided by one or more laminates 50.

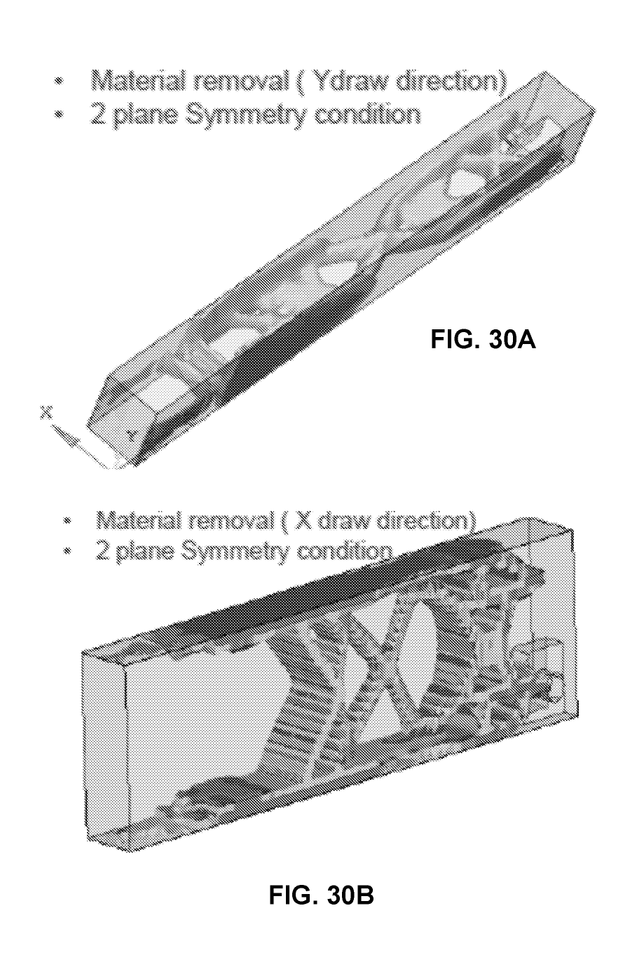

Solutions from the second scenario using various draw directions and symmetry conditions are depicted in FIGS. 30A and 30B. More particularly: (1) FIG. 30A depicts a solution using a draw direction along the y-axis (axes are shown in FIG. 26), a symmetry condition about a plane parallel to the Y-Z plane, and a symmetry condition about a plane parallel to the X-Z plane; and (2) FIG. 30B depicts a solution using a draw direction along the x-axis, a symmetry condition about a plane parallel to the Y-Z plane, and a symmetry condition about a plane parallel to the X-Z plane.

Some embodiments of the present armrests comprise: an elongated beam extending between a first end and a second end, the elongated beam including one or more laminates, each comprising a plurality of fibers dispersed within a matrix material, the one or more laminates configured to be disposed along the elongated beam such that the one or more laminates define an arch extending between the first and second ends, and a reinforcing structure including a plurality of ribs, the reinforcing structure configured to be coupled to the one or more laminates such that the plurality of ribs extend from the one or more laminates, wherein the first end of the elongated beam is configured to be pivotally coupled to a mount. In some embodiments, the one or more laminates define a channel extending between the first and second ends.

Some embodiments of the present armrests comprise: an elongated beam extending between a first end and a second end, the elongated beam including one or more laminates, each comprising a plurality of fibers dispersed within a matrix material, the one or more laminates configured to be disposed along the elongated beam such that the one or more laminates define a channel extending between the first and second ends, and a reinforcing structure including a plurality of ribs, the reinforcing structure configured to be coupled to the one of more laminates such that the plurality of ribs extend into the channel, wherein the first end of the elongated beam is configured to be pivotally coupled to a mount. In some embodiments, the one or more laminates define an arch extending between the first and second ends.

In some embodiments, the first end of the elongated beam is configured to be pivotally coupled to the mount such that the elongated beam is movable relative to the mount between a stowed position and a deployed position in which the elongated beam extends further from the mount in a horizontal direction than when in the stowed position. In some embodiments, the first end of the elongated beam defines one or more openings or slots configured to receive one or more fasteners to pivotally couple the elongated beam to the mount.

In some embodiments, the one or more laminates extend along a majority of the length of the elongated beam. In some embodiments, the one or more laminates define at least a portion of an outermost surface of the elongated beam. In some embodiments, at least one of the one or more openings or slots is defined through the one or more laminates and the reinforcing structure.

In some embodiments, for at least one of the one or more laminates, the plurality of fibers comprise carbon fibers, glass fibers, basalt fibers, textile fibers, or a combination thereof. In some embodiments, for at least one of the one or more laminates, the plurality of fibers comprise continuous fibers. In some embodiments, for at least one of the one or more laminates, the plurality of fibers comprise discontinuous fibers. In some embodiments, at least one of the one or more laminates comprises a first layer having continuous fibers aligned in a first direction and a second layer having continuous fibers aligned in a second direction that is angularly disposed relative to the first direction. In some embodiments, the smallest angle between the first direction and the second direction is from 20 to 70 degrees. In some embodiments, the smallest angle between the first direction and the second direction is from 30 to 60 degrees. In some embodiments, the smallest angle between the first direction and the second direction is from 40 to 50 degrees.

In some embodiments, the matrix material comprises a thermoplastic material, a thermoset material, or a combination thereof. In some embodiments, at least a portion of the reinforcing structure and the matrix material of at least one of the one or more laminates comprise the same material.

In some embodiments, a depth of the channel decreases from the first end to the second end. In some embodiments, the one or more laminates define a cross-section, taken perpendicularly to the length of the elongated beam, that is U-shaped. In some embodiments, the one or more laminates define one or more ridges extending into the channel. In some embodiments, the one or more laminates and the reinforcing structure are integrally formed (e.g., the reinforcing structure is overmolded onto the one or more laminates). In some embodiments, the one or more laminates define one or more openings or slots, and the reinforcing structure is disposed through the one or more openings or slots.

In some embodiments, the plurality of ribs of the reinforcing structure includes one or more longitudinal ribs extending in a direction that is substantially parallel to the length of the elongated beam. In some embodiments, the plurality of ribs of the reinforcing structure includes two or more transverse ribs extending in a direction that is substantially perpendicular to the length of the elongated beam. In some embodiments, a distance between the longitudinally consecutive ones of the two or more transverse ribs increases from the first end to the second end. In some embodiments, the plurality of ribs of the reinforcing structure includes a first rib extending in a direction that is angularly disposed relative to the length of the elongated beam and a second rib extending in a direction that is angularly disposed relative to the length of the elongated beam, wherein the first rib intersects the second rib.

In some embodiments, the elongated beam includes a cover configured to be coupled to the reinforcing structure. In some embodiments, the cover is configured to be coupled to the reinforcing structure via interlocking engagement of the cover and the reinforcing structure. In some embodiments, the cover is unitary with at least a portion of the reinforcing structure. In some embodiments, the cover is configured to extend around at least a portion of the one or more laminates at the second end.

Some embodiments comprise one or more support elements configured to be coupled between the mount and the elongated beam such that the one or more support elements physically limit movement of the elongated beam beyond the deployed position. In some embodiments, each of the one or more support elements is configured to be pivotally coupled to the mount and slidably coupled to the elongated beam.

Some embodiments comprise one or more elbow rests, each configured to be movably coupled to the elongated beam such that the elbow rest is movable relative to the elongated beam between a stowed position and a deployed position in which the elbow rest extends further from the elongated beam in a horizontal direction than when in the stowed position. In some embodiments, for each of the one or more elbow rests, a portion of the elbow rest that is disposed outside of the elongated beam when the elbow rest is in the deployed position is disposed within the elongated beam when the elbow rest is in the stowed position. In some embodiments, each of the one or more elbow rests is configured to be slidably coupled to the elongated beam.

In some embodiments, each of the one or more elbow rests is configured to be pivotally coupled to the elongated beam. In some embodiments, each of the one or more elbow rests is configured to be rotatable relative to the elongated beam between the stowed position and the deployed position and in a substantially horizontal plane. In some embodiments, each of the one or more elbow rests is configured to be rotatable relative to the elongated beam between the stowed position and the deployed position and in a substantially vertical plane.

Some embodiments comprise a divider configured to be movably coupled to the elongated beam such that the divider is movable relative to the elongated beam between a stowed position and a deployed position in which the divider extends further from the elongated beam in a vertical direction than when in the stowed position. In some embodiments, a portion of the divider that is disposed outside of the elongated beam when the divider is in the deployed position is disposed within the elongated beam when the divider is in the stowed position. In some embodiments, the divider is configured to be slidably coupled to the elongated beam. In some embodiments, the divider is configured to be pivotally coupled to the elongated beam.

Some embodiments of the present methods comprise overmolding a reinforcing structure (e.g., 142a, 142b, 142c, 142d, 142e, or the like) over one or more laminates (e.g., 50) Some embodiments of the present methods for forming an armrest comprise: overmolding a plastic material onto one or more laminates to form an elongated beam extending between a first end and a second end, each of the one or more laminates including a plurality of fibers dispersed within a matrix material, wherein the overmolding is performed such that the one or more laminates define an arched channel extending between the first and second ends, and the plastic material defines a reinforcing structure including a plurality of ribs, each extending into the arched channel.

Some embodiments of the present armrests comprise: a frame including a composite material, wherein the frame has sidewalls coupled with and extending from a base wall to define a cavity therebetween, ribs disposed in the cavity and coupling the sidewalls to the base wall, and a hinge member at least partially disposed in the cavity, wherein the hinge member extends between the sidewalls in a rear portion of the frame to encase a portion of the cavity, and a cover configured to be attached to the hinge member such that the cover overlies the cavity from the hinge member to a front portion of the frame. At least one of the ribs can define a recess or opening configured to receive a linkage or wiring associated with the armrest, such as, for example a hinge release cable. In some embodiments, the frame includes a thermoplastic polymer, glass fibers, and/or carbon fibers.

In some embodiments, the cover includes a tab configured to connect the cover to the hinge member. In some embodiments, the cover includes a rib projecting from a lower surface of the cover and extending along a length of the cover. In some embodiments, when the cover is coupled to the frame, the rib is received by one or more recesses that are each defined, at least in part, by a respective one of the ribs. In some embodiments, the cover is configured to be coupled to the frame via one or more fasteners. For example, such a fastener can be received by a boss of the cover and/or a boss of the frame.

In some embodiments, the cover includes a first layer and a second layer, and, when the cover is coupled to the frame, at least a portion of the first layer is disposed between at least a portion of the second layer and the frame. In some embodiments, the first layer has a higher stiffness than the second layer. In some embodiments, at least a majority (e.g., by volume and/or weight) of the first layer comprises a first material, and at least a majority (e.g., by volume and/or weight) of the second layer comprises a second material that is different than the first material (e.g., the first material can have a higher hardness than the second material). The second material can include, for example, a thermoplastic elastomer, such as a polyolefin, a styrenic block copolymer, a polyurethane, a copolyester, a polyamide, a foam, and/or the like. The second layer can be overmolded onto the first layer. In some embodiments, the first layer can be characterized as a base or a pedestal, and the second layer can be characterized as a cap.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1-2. (canceled)

3. An armrest comprising:
an elongated beam extending between a first end and a second end, the elongated beam including:
one or more laminates, each comprising a plurality of fibers dispersed within a matrix material, the one or more laminates configured to be disposed along the elongated beam such that the one or more laminates define a channel having a bottom portion and opposing side portions that each extend away from the bottom portion, the channel extending between the first and second ends; and
a reinforcing structure including a plurality of ribs, the reinforcing structure configured to be coupled to the one or more laminates such that the plurality of ribs extend into the channel;
wherein the first end of the elongated beam is configured to be pivotally coupled to a mount.

4. The armrest of claim 3, wherein the one or more laminates define an arch extending between the first and second ends.

5. The armrest of claim 3, wherein a depth of the channel decreases from the first end to the second end.

6. The armrest of claim 3, wherein the one or more laminates extend along a majority of the length of the elongated beam.

7. The armrest of claim 3, wherein the one or more laminates define at least a portion of an outermost surface of the elongated beam.

8. The armrest of claim 3, wherein:
the one or more laminates define one or more openings or slots; and
the reinforcing structure is disposed through the one or more openings or slots.

9. The armrest of claim 3, wherein the elongated beam includes a cover configured to be coupled to the reinforcing structure.

10. The armrest of claim 9, wherein the cover is configured to be coupled to the reinforcing structure via interlocking engagement of the cover and the reinforcing structure.

11. The armrest of claim 9, wherein the cover is unitary with at least a portion of the reinforcing structure.

12. The armrest of claim 9, wherein the cover is configured to extend around at least a portion of the one or more laminates at the second end.

13. The armrest of claim 3, wherein:
the first end of the elongated beam defines one or more openings or slots configured to receive one or more fasteners to pivotally couple the elongated beam to the mount; and
at least one of the one or more openings or slots is defined through the one or more laminates and the reinforcing structure.

14. The armrest of claim 3, wherein:
the first end of the elongated beam is configured to be pivotally coupled to the mount such that the elongated beam is movable relative to the mount between a stowed position and a deployed position in which the elongated beam extends further from the mount in a horizontal direction than when in the stowed position; and
the armrest comprises one or more support elements configured to be coupled between the mount and the elongated beam such that the one or more support elements physically limit movement of the elongated beam beyond the deployed position.

15. The armrest of claim 3, comprising one or more elbow rests, each configured to be movably coupled to the elongated beam such that the elbow rest is movable relative to the elongated beam between a stowed position and a deployed position in which the elbow rest extends further from the elongated beam in a horizontal direction than when in the stowed position.

16. The armrest of claim 15, wherein, for each of the one or more elbow rests, a portion of the elbow rest that is disposed outside of the elongated beam when the elbow rest is in the deployed position is disposed within the elongated beam when the elbow rest is in the stowed position.

17. The armrest of claim 3, comprising a divider configured to be movably coupled to the elongated beam such that the divider is movable relative to the elongated beam between a stowed position and a deployed position in which the divider extends further from the elongated beam in a vertical direction than when in the stowed position.

18. The armrest of claim 3, wherein at least a portion of the reinforcing structure and the matrix material of at least one of the one or more laminates comprise the same material.

19. (canceled)

20. A method for forming an armrest, the method comprising:
overmolding a plastic material onto one or more laminates to form an elongated beam extending between a first end and a second end, each of the one or more laminates including a plurality of fibers dispersed within a matrix material;
wherein the overmolding is performed such that:
the one or more laminates define an arched channel having a bottom portion and opposing side portions that each extend away from the bottom portion, the channel extending between the first and second ends; and
the plastic material defines a reinforcing structure including a plurality of ribs, each extending into the arched channel.
